(19) United States
(12) Patent Application Publication
(10) Pub. No.: US 2019/0383654 A1
(43) Pub. Date: Dec. 19, 2019

(54) PHYSICAL QUANTITY DETECTION DEVICE

(71) Applicant: DENSO CORPORATION, Kariya-city (JP)

(72) Inventor: Kengo ITO, Kariya-city (JP)

(21) Appl. No.: 16/554,922

(22) Filed: Aug. 29, 2019

Related U.S. Application Data
(63) Continuation of application No. PCT/JP2018/008669, filed on Mar. 7, 2018.

(30) Foreign Application Priority Data
Mar. 15, 2017 (JP) 2017-050295

(51) Int. Cl. G01F 1/684; G01F 1/86; G01F 1/696

(52) U.S. Cl. CPC G01F 1/684; G01F 15/14; G01F 1/696; G01F 1/86

(57) ABSTRACT

A physical quantity detection device includes a sensor element that generates a detection signal of the physical quantity and a conversion circuit that converts the detection signal generated by the sensor element into an output signal. The conversion circuit includes a set number of output units each corresponding to a respective one of a set number of communication methods, each of the output units being capable of generating the output signals conforming to their corresponding communication method, the set number being two or more, a storage unit that stores method specifying information which specifies a communication method, to be applied to the mounting target, among the set number of communication methods, and a selection unit that selects an output unit, which outputs the output signal, among the set number of output.

### CROSS-REFERENCE TO RELATED APPLICATIONS

The present application is a continuation application of International Patent Application No. PCT/JP2018/008669 filed on Mar. 7, 2018, which designated the U.S. and claims the benefit of priority from Japanese Patent Application No. 2017-50295 filed on Mar. 15, 2017. The entire disclosures of all of the above applications are incorporated herein by reference.

### TECHNICAL FIELD

The present disclosure relates to a physical quantity detection device for detecting a physical quantity of a gas flowing through a passage at a mounting target.

### BACKGROUND

A physical quantity detection device, such as a gas flow detector, may convert a detection signal, which is generated by a sensor element for detecting a physical quantity, into an output signal by processing using a conversion circuit.

### SUMMARY

According to one aspect of the present disclosure, a physical quantity detection device for detecting a physical quantity of a gas that flows through a passage in a mounting target includes a sensor element that generates a detection signal of the physical quantity, and a conversion circuit that converts the detection signal generated by the sensor element into an output signal, where the conversion circuit includes a set number of output units each corresponding to a respective one of a set number of communication methods, each of the output units being capable of generating the output signals conforming to their corresponding communication method, the set number being two or more, a storage unit that stores method specifying information which specifies a communication method, to be applied to the mounting target, among the set number of communication methods, and a selection unit that selects an output unit, which outputs the output signal, among the set number of output units according to the method specifying information stored in the storage unit.

According to a second aspect of the present disclosure, the conversion circuit includes a plurality of output terminals configured to output the output signal from at least one of the set number of output units, a plurality of the sensor elements are provided to detect different physical quantities, and when a maximum value of the number of the output signals that can be generated based on the detection signal of each of the sensor elements is defined as a maximum number of signals for each set number of output units, the number of the output terminals coincides with the maximum number of signals.

### BRIEF DESCRIPTION OF DRAWINGS

The above and other objects, features and advantages of the present disclosure will become more apparent from the following detailed description made with reference to the accompanying drawings. In the drawings:

FIG. 1 is a schematic configuration diagram showing an engine system of a vehicle according to first to seventh embodiments.

FIG. 2 is a schematic diagram showing a communication method applicable to the vehicle according to the first to seventh embodiments.

FIG. 3 is a schematic diagram showing a communication method applicable to the vehicle according to the first to seventh embodiments.

FIG. 4 is a schematic diagram showing a communication method applicable to the vehicle according to the first to seventh embodiments.

FIG. 5 is a schematic diagram showing a communication method applicable to the vehicle according to the first to fourth, sixth, and seventh embodiments.

FIG. 6 is a schematic diagram showing a communication method applicable to the vehicle according to the first to seventh embodiments.

FIG. 7 is a cross-sectional view taken along a line VII-VII of FIG. 8 showing a state in which a physical quantity detection device is mounted on the vehicle according to the first embodiment.

FIG. 8 is a cross-sectional view taken along a line VIII-VIII of FIG. 7 showing a state in which a physical quantity detection device is mounted on the vehicle according to the first embodiment.

FIG. 9 is a side view taken along a line IX-IX of FIG. 7 showing a state in which a physical quantity detection device is mounted on the vehicle according to the first embodiment.

FIG. 10 is a block diagram showing a physical quantity detection device according to the first embodiment.

FIG. 11 is a block diagram showing a physical quantity detection device according to a second embodiment.

FIG. 12 is a cross-sectional view corresponding to FIG. 7, showing a state in which a physical quantity detection device is mounted on a vehicle according to a third embodiment.

FIG. 13 is a block diagram showing the physical quantity detection device according to the third embodiment.

FIG. 14 is a block diagram showing the physical quantity detection device according to the third embodiment.

FIG. 15 is a side view corresponding to FIG. 9, showing a state in which the physical quantity detection device is mounted on the vehicle according to the third embodiment.

FIG. 16 is a block diagram showing a physical quantity detection device according to a fourth embodiment.

FIG. 17 is a block diagram showing a physical quantity detection device according to a fifth embodiment.

FIG. 18 is a schematic diagram showing a communication method applicable to the vehicle according to the fifth embodiment.

FIG. 19 is a cross-sectional view corresponding to FIG. 7, showing a state in which a physical quantity detection device is mounted on a vehicle according to a sixth embodiment.

FIG. 20 is a block diagram showing the physical quantity detection device according to the sixth embodiment.

FIG. 21 is a block diagram showing a physical quantity detection device according to the sixth embodiment.

FIG. 22 is a side view corresponding to FIG. 9, showing a state in which the physical quantity detection device is mounted on a vehicle according to the sixth embodiment.

FIG. 23 is a block diagram showing a physical quantity detection device according to a seventh embodiment.

FIG. 24 is a block diagram showing a physical quantity detection device according to a modification of FIG. 10.

FIG. 25 is a block diagram showing the physical quantity detection device according to the modification of FIG. 10.

FIG. 26 is a block diagram showing a physical quantity detection device according to a modification of FIG. 13.

FIG. 27 is a block diagram showing a physical quantity detection device according to a modification of FIG. 20.

### DETAILED DESCRIPTION

Hereinafter, a plurality of embodiments will be described with reference to the drawings. Incidentally, the same reference numerals are assigned to the corresponding components in each embodiment, and thus, duplicate descriptions may be omitted. When only a part of the configuration is described in each embodiment, the configuration of the other embodiments described above can be applied to other parts of the configuration. Further, not only the combinations of the configurations explicitly shown in the description of the respective embodiments, but also the configurations of the plurality of embodiments can be partially combined even if the combinations are not explicitly shown if there is no problem in the combination in particular.

### First Embodiment

Typically, a physical quantity detection device may convert a detection signal, which is generated by a sensor element for detecting a physical quantity, into an output signal by processing using a conversion circuit. In this kind of physical quantity detection devices, for example, a communication with external systems may be performed through a communication method such as SENT (Single Edge Nibble Transmission), LIN (Local Interconnect Network), CAN (Controller Area Network), or the like.

A particular device may be configured such that a circuit configuration of the conversion circuit is specialized for a LIN communication method. When a circuit configuration compliant with a single communication method is employed as in this case, a device variation having a different conversion circuit for converting a detection signal into an output signal must be prepared each time a communication method determined by specifications of a mounting target or the like is changed. In that case, since a production process for each device variation conforming to each communication method is required, productivity may be lowered. It is with this productivity concern that a physical quantity detection device 10 is described below.

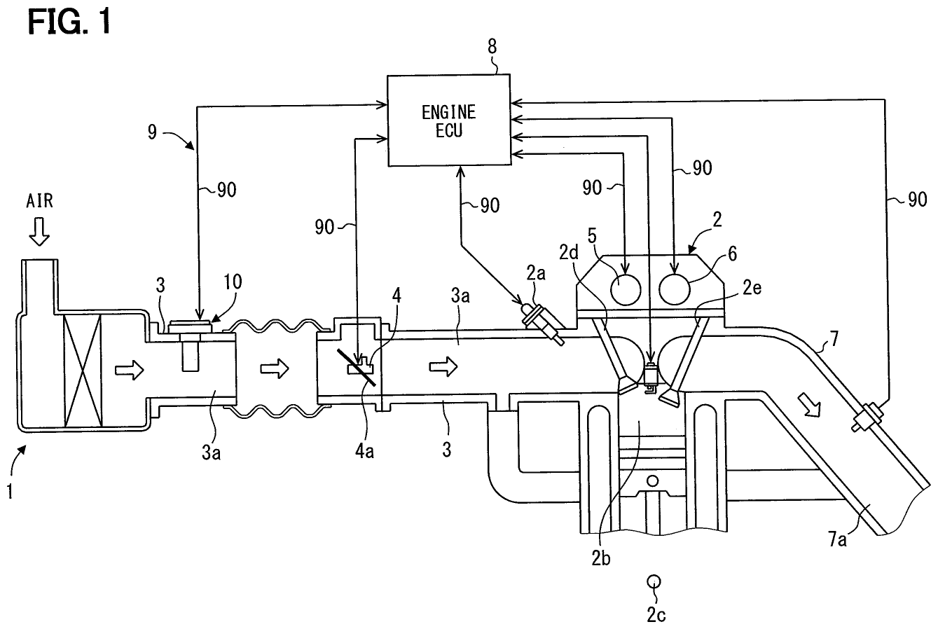

As shown in FIG. 1, the physical quantity detection device 10 according to the first embodiment is mounted on an engine system 1 of a vehicle which is a “mounting target”. The engine system 1 includes an internal combustion engine 2, an intake pipe 3, a throttle device 4, an intake valve timing adjustment device 5, an exhaust valve timing adjustment device 6, an exhaust pipe 7, an engine ECU (Electronic Control Unit) 8, and an in-vehicle network 9 together with a physical quantity detection device 10.

The internal combustion engine 2 combusts a fuel injected from an injector 2a in a cylinder 2b, thereby outputting a rotational driving force for allowing the vehicle to travel from a crankshaft 2c. An intake passage 3a defined by the intake pipe 3 allows an air as a “gas” to be mixed with the fuel injection from the injector 2a to flow through the intake passage 3a and to be drawn into the cylinder 2b. The throttle device 4 adjusts a flow rate of an intake air in the intake passage 3a by opening and closing the throttle valve 4a. The intake valve timing adjustment device 5 adjusts the opening and closing timing of the intake valve 2d in the internal combustion engine 2. The exhaust valve timing adjustment device 6 adjusts the opening and closing timing of the exhaust valve 2e in the internal combustion engine 2. The exhaust passage 7a defined by the exhaust pipe 7 allows an exhaust gas generated by the combustion in the internal combustion engine 2 to flow through the exhaust passage 7a and discharges the exhaust gas to the outside of the vehicle.

The engine ECU 8 is mainly configured by a microcomputer, and is electrically connected to electrical components such as the injector 2a in the internal combustion engine 2, the throttle device 4, the valve timing adjustment devices 5 and 6, and the physical quantity detection device 10 so as to be able to communicate with each other through an in-vehicle network 9. The engine ECU 8 controls the operation of the other electrically connected components based on the output signal of the physical quantity detection device 10 and the like. At that time, the engine ECU 8 can acquire the operation information of the throttle device 4 and the valve timing adjustment devices 5 and 6.

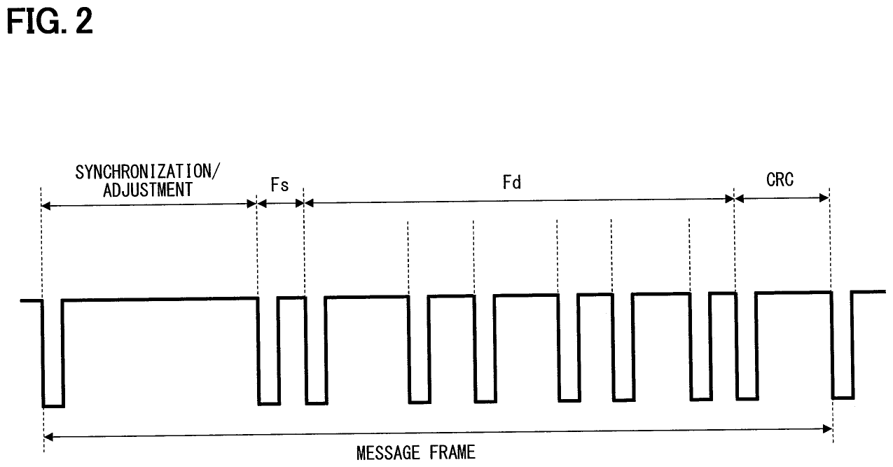

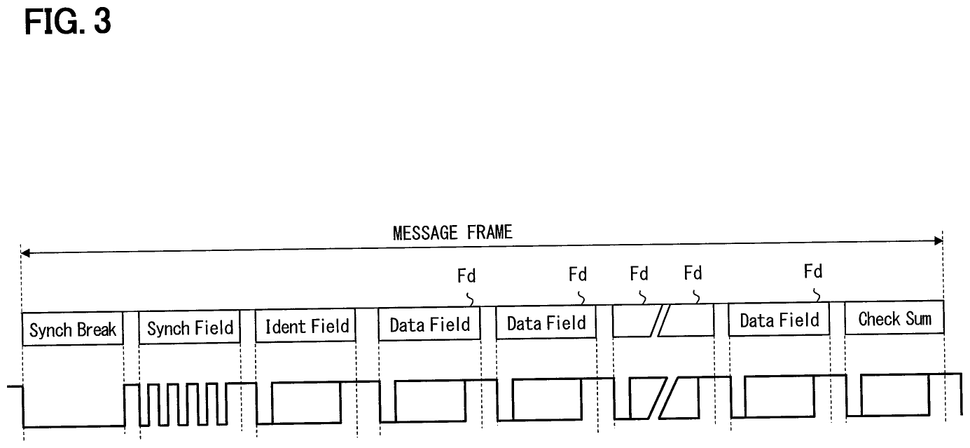

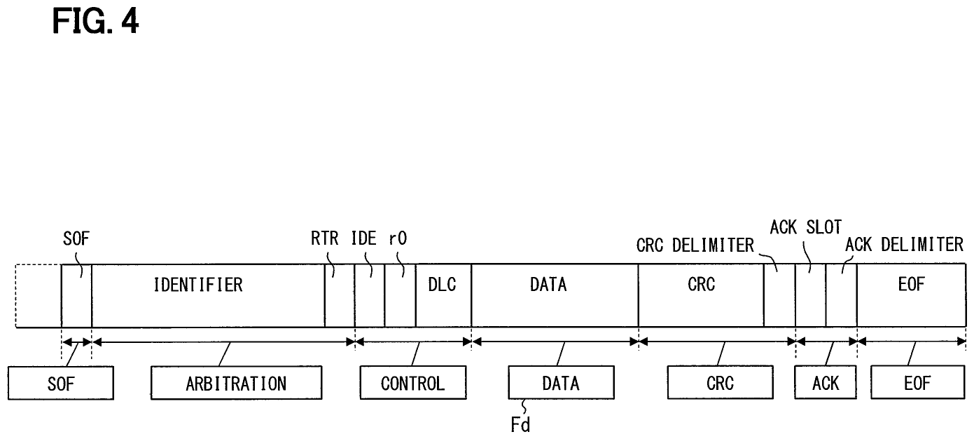

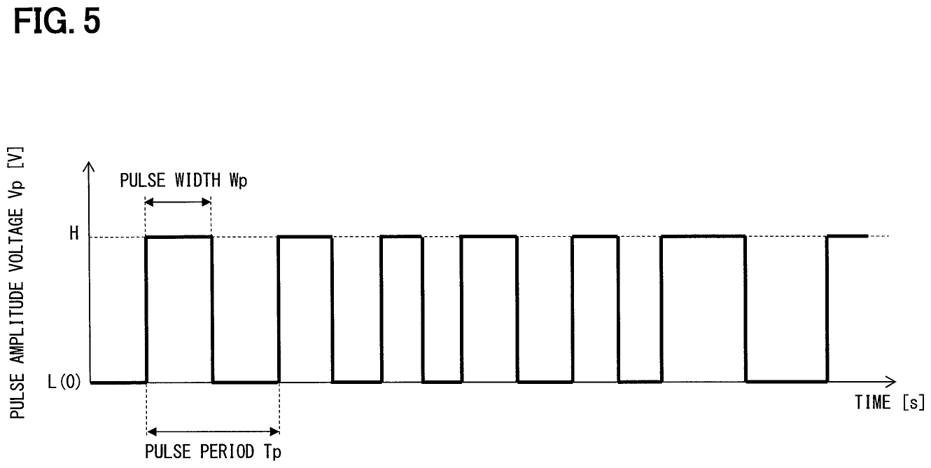

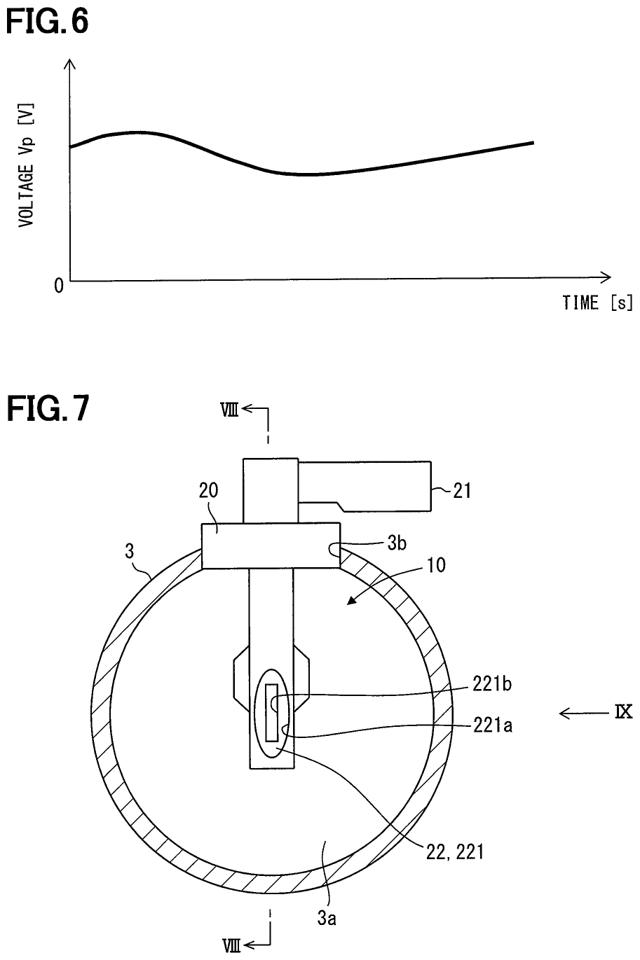

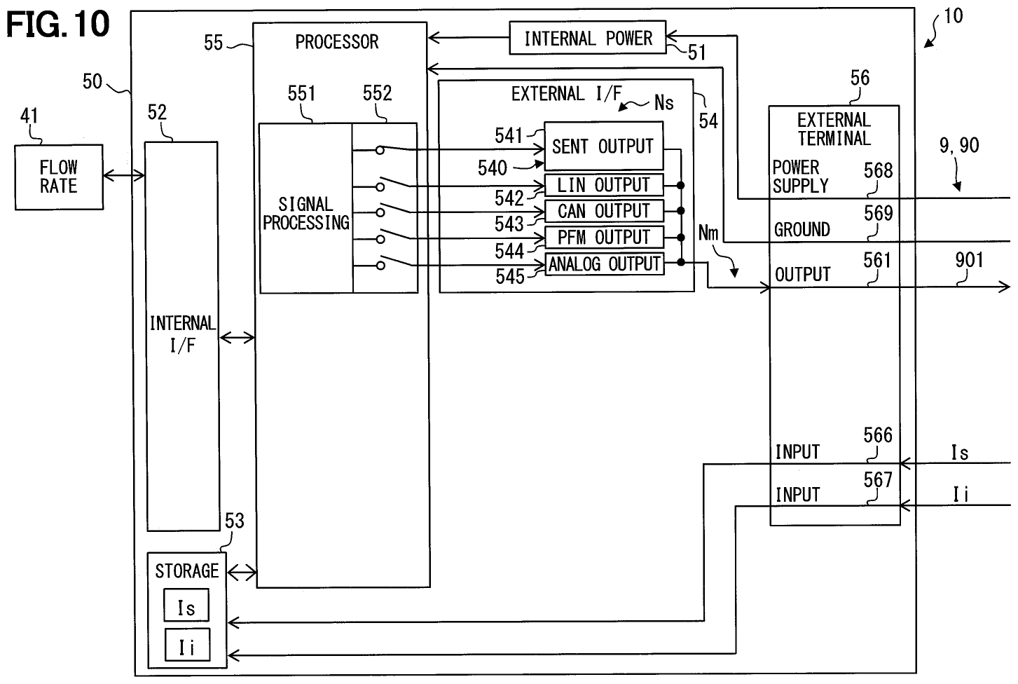

The in-vehicle network 9 mainly includes multiple wire harnesses 90. The communication methods which are supposed to be applicable to the in-vehicle network 9 according to the specification of the vehicle include five communication methods shown in FIGS. 2 to 6. FIG. 2 shows a signal generated according to a SENT communication method. FIG. 3 shows a signal generated according to an LIN communication method. FIG. 4 shows a signal generated according to a single-line CAN communication method. FIG. 5 shows a signal generated in accordance with a PFM (Pulse Frequency Modulation) communication method. FIG. 6 shows a signal generated according to an analog voltage communication method. As described above, the set number Ns of the communication methods applicable to the vehicle (refer to FIG. 10 to be described later) is set to five which is two or more in the first embodiment.

As shown in FIGS. 7 to 9, the physical quantity detection device 10 is attached to an attachment hole 3b of the intake pipe 3. The physical quantity detection device 10 includes a housing 20, a circuit board 30, a sensor element 41, and a conversion circuit 50.

The housing 20 is made of a heat-resistant resin and formed in a block shape. The housing 20 is installed so as to extend across an inside and an outside of the intake pipe 3 by fitting through the attachment hole 3b. The housing 20 has a connector 21 on the outside of the intake pipe 3, which is mechanically connected to a wire harness 90 (refer to FIGS. 1 and 10) connecting to the engine ECU 8 as the in-vehicle network 9. The housing 20 includes a bypass passage 22 at a location exposed to the intake passage 3a within the intake pipe 3. Part of the intake air flowing through the intake passage 3a and drawn into the cylinder 2b of the internal combustion engine 2 is diverted from the intake passage 3a to the bypass passage 22.

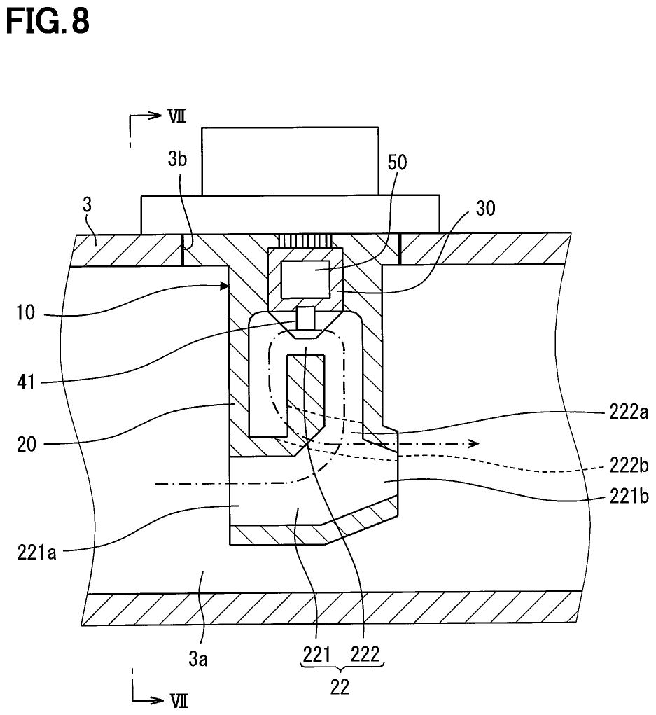

In this example, as shown in FIGS. 7 and 8, the bypass passage 22 is configured by a first passage portion 221 and a second passage portion 222. The first passage portion 221 opens both an inlet 221a and an outlet 221b to the intake passage 3a. The first passage portion 221 allows the intake air to flow between the inlet 221a and the outlet 221b in substantially the same direction as the intake passage 3a (refer to a one-dot dash arrow in FIG. 8). The second passage portion 222 opens an inlet 222a to an intermediate portion of the first passage portion 221, and opens an outlet 222b to the intake passage 3a. The second passage portion 222 circulates the intake air between the inlet 222a and the outlet 222b in a direction opposite to the intake passage 3a, and then circulates the intake air in the same direction as the passage 3a (refer to a one-dot dash arrow in FIG. 8). With the configuration described above, foreign matter in the intake air is less likely to enter the second passage portion 222 in the bypass passage 22.

As shown in FIG. 8, the circuit board 30 is made of a hard material and formed in a flat plate-like shape. The circuit board 30 is enclosed in the housing 20. A single sensor element 41 is mounted on the circuit board 30 of the first embodiment. The sensor element 41 is exposed to the second passage portion 222 of the bypass passage 22 in the housing 20. The sensor element 41, such as a hot wire type or a Karman vortex type, detects a flow rate of the intake air flowing through the intake passage 3a and flowing into the second passage portion 222 as a “physical quantity”. Therefore, the sensor element 41 generates and outputs a detection signal representing the detected flow rate at any time. At that time, the detection signal of the flow rate output from the sensor element 41 may be either an analog signal or a digital signal.

The conversion circuit 50 is mounted on the circuit board 30 in the housing 20. The conversion circuit 50 is an electronic circuit that processes and converts the detection signal generated by the sensor element 41 into an output signal. As shown in FIG. 10, the conversion circuit 50 includes an internal power unit 51, an internal interface 52, a storage unit 53, an external interface 54, a processor unit 55, and an external terminal unit 56.

The internal power unit 51 mainly includes a regulator, and is electrically connected to a battery of the vehicle through an external terminal unit 56. The internal power unit 51 supplies a stable power supply voltage to each of the interfaces 52 and 54 and each of the units 53, 55, and 56 regardless of a state of charge of the battery. FIG. 10 shows only an electric connection state of the internal power unit 51 to the processor unit 55 among power supply targets and omits an illustration of the electric connection state of the internal power unit 51 to the other power supply targets.

The internal interface 52 mainly includes an analog-to-digital converter when the detection signal of the sensor element 41 is an analog signal, and converts the detection signal input to the processor unit 55 into a digital signal. On the other hand, when the detection signal of the sensor element 41 is a digital signal, the internal interface 52 mainly includes an input buffer, and adjusts a signal level and the like of the detection signal input to the processor unit 55.

The storage unit 53 is mainly configured by a memory such as an EEPROM (Electrically Erasable Programmable Read-Only Memory). The storage unit 53 stores, for a long period of time, method specifying information Is for specifying the communication method to be applied to the actual vehicle, among the communication methods of the set number Ns assumed for the vehicle. At the same time, the storage unit 53 stores correlation calibration information Ii for calibrating a correlation between the detection value of the flow rate by the sensor element 41 and the detection signal for a long period of time. In this example, the correlation calibration information Ii is information which is defined in advance at the time of manufacturing a product of the device 10 and is stored in the storage unit 53 in order to calibrate a detection value correlated with a signal value such as an amplitude of the detection signal to an ideal value in accordance with the sensor element 41 actually provided in the physical quantity detection device 10.

The external interface 54 is formed by combining multiple output units 541, 542, 543, 544, and 545 together. In the first embodiment, five output units 541, 542, 543, 544, and 545 are provided so as to individually correspond to the communication methods of the set number Ns assumed for the vehicle.

The detection signal of the sensor element 41 is input through the processor unit 55 to one actual output unit 540 (the first output unit 541 in an example of FIG. 10) conforming to the communication method applied to the actual vehicle among the output units 541, 542, 543, 544, and 545. However, the actual applied communication method follows the method specifying information Is stored in the storage unit 53 at the time of manufacturing the product as will be described later in detail. Therefore, any of the output units 541, 542, 543, 544, and 545 can generate an output signal conforming to the corresponding communication method based on the detection signal of one sensor element 41 and can output the output signal to the external terminal unit 56.

In this example, the output signal of the first output unit 541 is generated in accordance with the SENT communication method shown in FIG. 2 so that the detection value of the flow rate is represented by a data field Fd. The output signal of the second output unit 542 is generated in accordance with the LIN communication method shown in FIG. 3 so as to represent the detection value of the flow rate in the data field Fd. The output signal of the third output unit 543 is generated in accordance with a single-line CAN communication method shown in FIG. 4 so that the detection value of the flow rate is represented by the data field Fd. The output signal of the fourth output unit 544 is generated in accordance with the PFM communication method shown in FIG. 5 so that the detection value of the flow rate is represented by a length of a pulse period Tp at a constant level of a duty ratio Wp/Tp and a pulse amplitude voltage Vp based on a pulse width Wp. An output signal of the fifth output unit 545 is generated in accordance with the analog voltage communication method shown in FIG. 6 so that the detection value of the flow rate is represented by the magnitude of the voltage Vp.

As described above, the number of output signals that can be generated based on the detection signal of the sensor element 41 for each of the output units 541, 542, 543, 544, and 545 of the set number Ns is one. As described above, in the first embodiment shown in FIG. 10, the maximum number of signals Nm that becomes the maximum value of the number of the output signals that can be generated for each of the output units 541, 542, 543, 544, and 545 is defined as one that is the same as the number of the sensor elements 41.

The processor unit 55 is configured mainly by a microcomputer. The processor unit 55 executes the control program, thereby functionally configuring a signal processing block 551 and a selection processing block 552. The signal processing block 551 performs necessary signal processing on the detection signal input from the sensor element 41 through the internal interface 52. At that time, in the signal processing of the signal processing block 551, the correlation calibration information Ii stored in the storage unit 53 is read out, and the detection value represented by the detection signal is calibrated to a value corresponding to the same information Ii.

The selection processing block 552 switches an actual output unit 540 for inputting the detection signal of the sensor element 41 processed by the signal processing block 551 among the output units 541, 542, 543, 544, and 545 of the set number Ns. As a result, the selection processing block 552 selects the actual output unit 540 that actually outputs the output signal to the external terminal unit 56. At that time, the selection processing block 552 reads out the method specifying information Is stored in the storage unit 53 and follows the method specifying information Is, thereby making it possible to appropriately select the actual output unit 540 conforming to the communication method applied to the actual vehicle. As described above, in the first embodiment, the functional part of the processor unit 55 for configuring the selection processing block 552 corresponds to a “selection unit”. In FIG. 10, in order to make the image of the selection processing block 552 understandable, the function of the selection processing block 552 is schematically illustrated by a switch symbol.

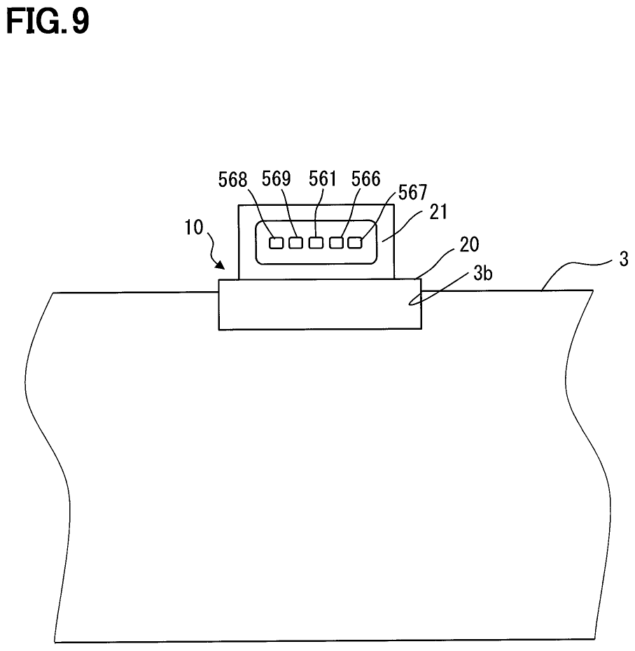

The external terminal unit 56 includes a single output terminal 561, a pair of input terminals 566 and 567, and a combination of a power supply terminal 568 and a ground terminal 569. Each of those terminals 561, 566, 567, 568, and 569 is made of a conductive hard metal, and all of those terminals are included in the connector 21 as shown in FIG. 9. In this example, the connector 21 is formed in a shape common to the communication methods of the set number Ns, thereby being capable of being mechanically connected to the wire harness 90 of FIG. 10 regardless of the actual communication method applied to the vehicle.

In the first embodiment, one output terminal 561 is provided. In other words, the number of output terminals 561 matches the maximum number of signals Nm defined in the external interface 54. Each of the output units 541, 542, 543, 544, and 545 is electrically connected to a common output terminal 561, so that the generated output signal can be output to the terminal 561. However, in the selected product state of the actual output unit 540 as described above among the output units 541, 542, 543, 544, and 545, only the output signal is output from the unit 540. A signal line 901 included in the wire harness 90 is electrically connected to the output terminal 561. Therefore, the output signal output from the actual output unit 540 to the output terminal 561 is input to the engine ECU 8 through the signal line 901.

The first input terminal 566 is electrically connected to the storage unit 53 through an interface (not shown) having a configuration similar to that of the internal interface 52 and the processor unit 55. A signal representing the method specifying information Is is input to the first input terminal 566 in advance in a storage process at the time of manufacturing a product. In this example, for example, an external device such as a computer storing the method specifying information Is is temporarily electrically connected to the first input terminal 566 at the time of manufacturing a product, thereby being capable of inputting a signal from the external device to the first input terminal 566. In response to such a signal input to the first input terminal 566, the processor unit 55 is configured to store the method specifying information Is in the storage unit 53 for a long period of time.

The second input terminal 567 is electrically connected to the storage unit 53 through an interface (not shown) having a configuration similar to that of the internal interface 52 and the processor unit 55. A signal representing the correlation calibration information Ii is input to the second input terminal 567 in advance in a storage process at the time of manufacturing the product. In this example, for example, an external device such as a computer storing the correlation calibration information Ii is temporarily electrically connected to the second input terminal 567 at the time of manufacturing a product, thereby being capable of inputting a signal from the external device to the second input terminal 567. Thus, the processor unit 55 is configured to store the correlation calibration information Ii in the storage unit 53 in response to the signal input to the second input terminal 567, for a long period of time.

The power supply terminal 568 is electrically connected to the battery of the vehicle. The ground terminal 569 is electrically connected to a metal body or the like of the vehicle to be grounded. The internal power unit 51 is electrically connected to the power supply terminal 568 and the ground terminal 569 to adjust a voltage applied from the battery to a voltage supplied to the interfaces 52 and 54 and the units 53, 55, and 56.

The operation and effects of the first embodiment described so far will be described below.

According to the first embodiment, the conversion circuit 50 for converting the detection signal generation by the sensor element 41 into the output signal is provided with a set number Ns, which is two or more, of output units 541, 542, 543, 544, and 545 individually corresponding to the set number of communication methods so that the output signals conforming to the corresponding communication methods can be generated. Therefore, in the conversion circuit 50, the actual output unit 540 which actually outputs the output signal among the output units 541, 542, 543, 544, and 545 of the set number Ns is selected by the selection processing block 552 of the processor unit 55 in accordance with the method specifying information Is stored in the storage unit 53 and specifying the communication method to be applied to the vehicle. According to the above configuration, the method specifying information Is stored in the storage unit 53 is changed according to the communication method applied to the vehicle, thereby being capable of preparing different device variations even in the same circuit configuration. Therefore, if the method specifying information Is stored in the storage unit 53 is changed among the device variations conforming to each of the communication methods, the production process of the circuit configuration other than the storage process can be made common, thereby being capable of enhancing the productivity. As a result of such commonality, the costs can be reduced.

According to the conversion circuit 50 of the first embodiment, when a signal representing the method specifying information Is is input to the first input terminal 566, the method specifying information Is is stored in the storage unit 53. According to the above configuration, after the same circuit configuration is manufactured by the common production process, different method specifying information Is conforming to the communication method applied to the vehicle can be easily stored in the storage unit 53. This makes it possible to contribute to achievement of high productivity.

Further, according to the first embodiment, the connector 21 including the single output terminal 561 is formed in a shape common to the communication methods of the set number Ns. According to the above configuration, not only the circuit configuration including the output terminal 561 but also the connector 21 for protecting the terminal 561 by inclusion can be configured in a common production process to enhance productivity. cl Second Embodiment

A second embodiment is a modification of the first embodiment.

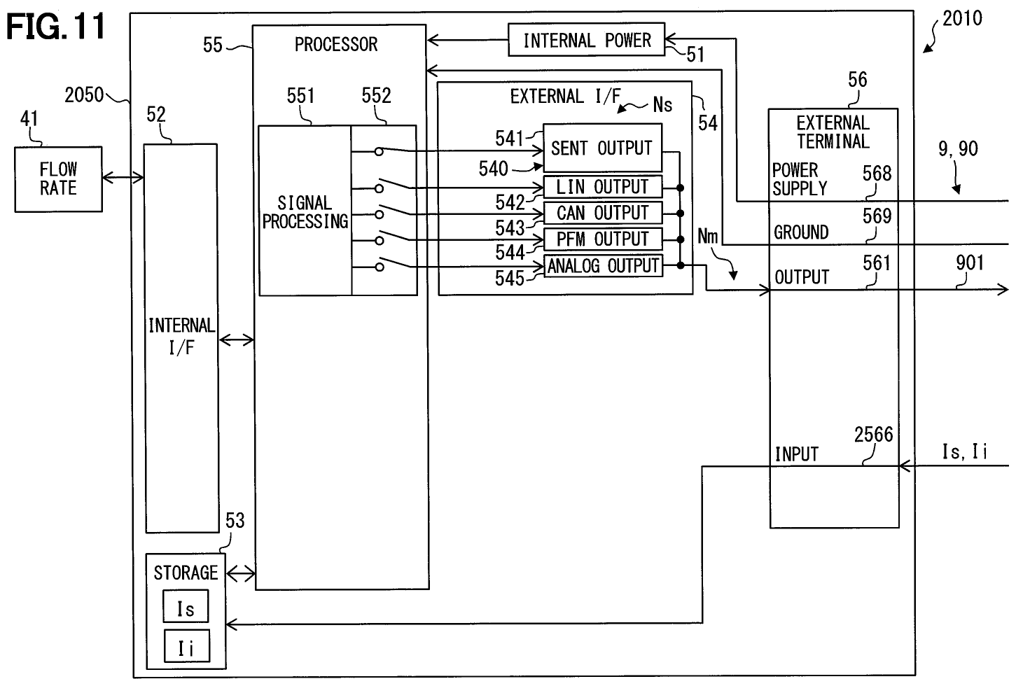

As shown in FIG. 11, in a conversion circuit 2050 of a physical quantity detection device 2010 according to the second embodiment, the input terminals 566 and 567 of the first embodiment are integrated into a single input terminal 2566. As a result, a signal representing method specifying information Is and a signal representing correlation calibration information Ii are input to the input terminal 2566 in advance in a storage process at the time of manufacturing a product. In this example, in particular, it is preferable that the input of the signal representing the correlation calibration information Ii is sequentially executed before and after the input of the signal representing the method specifying information Is.

According to the second embodiment described above, in addition to the signal representing the method specifying information Is, a signal representing the correlation calibration information Ii for calibrating the correlation between the detection value by the sensor element 41 and the detection signal is also input to the same input terminal 2566. According to the above configuration, the method specifying information Is and the correlation calibration information Ii are successively input to the input terminal 2566, thereby being capable of easily executing the storage of the method specifying information Is and the storage of the correlation calibration information Ii continuously or intermittently. Therefore, high detection accuracy by calibration can be achieved with high productivity.

### Third Embodiment

A third embodiment is a modification of the first embodiment.

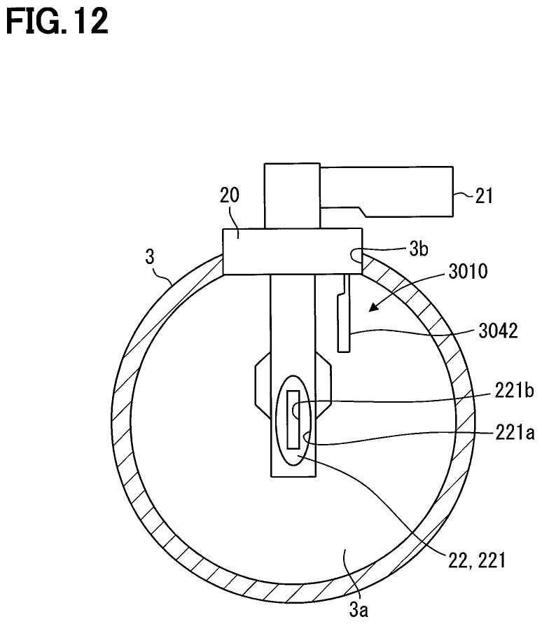

As shown in FIGS. 12 to 14, a physical quantity detection device 3010 according to the third embodiment includes multiple sensor elements 3041 and 3042 configured to detect different “physical quantities”. Specifically, in addition to the first sensor element 3041 having substantially the same configuration as that of the sensor element 41 in the first embodiment, another second sensor element 3042 is provided.

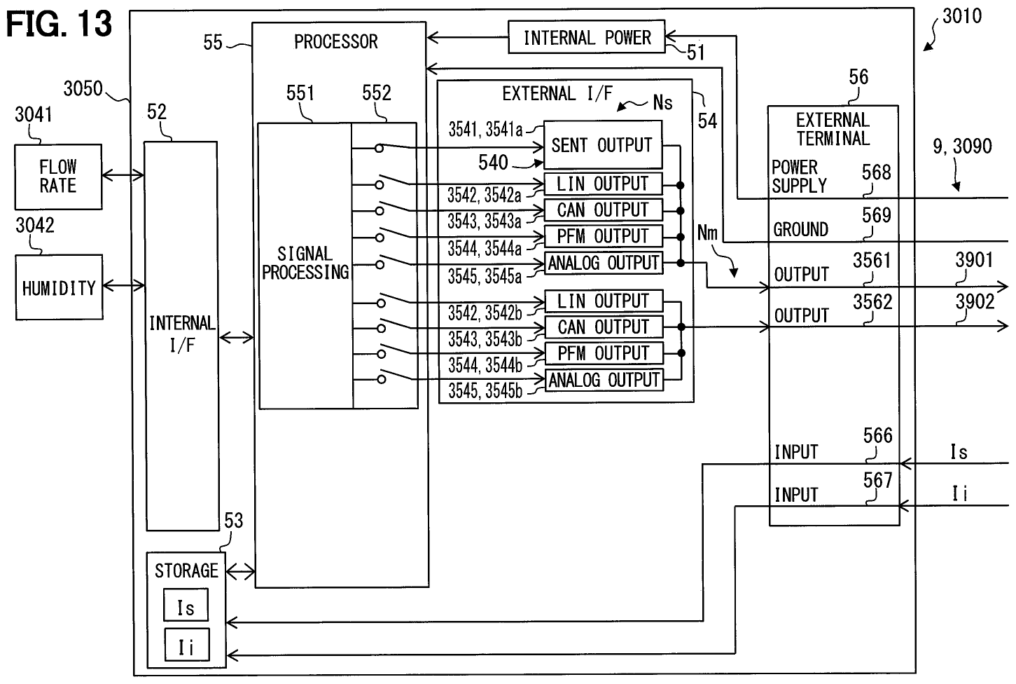

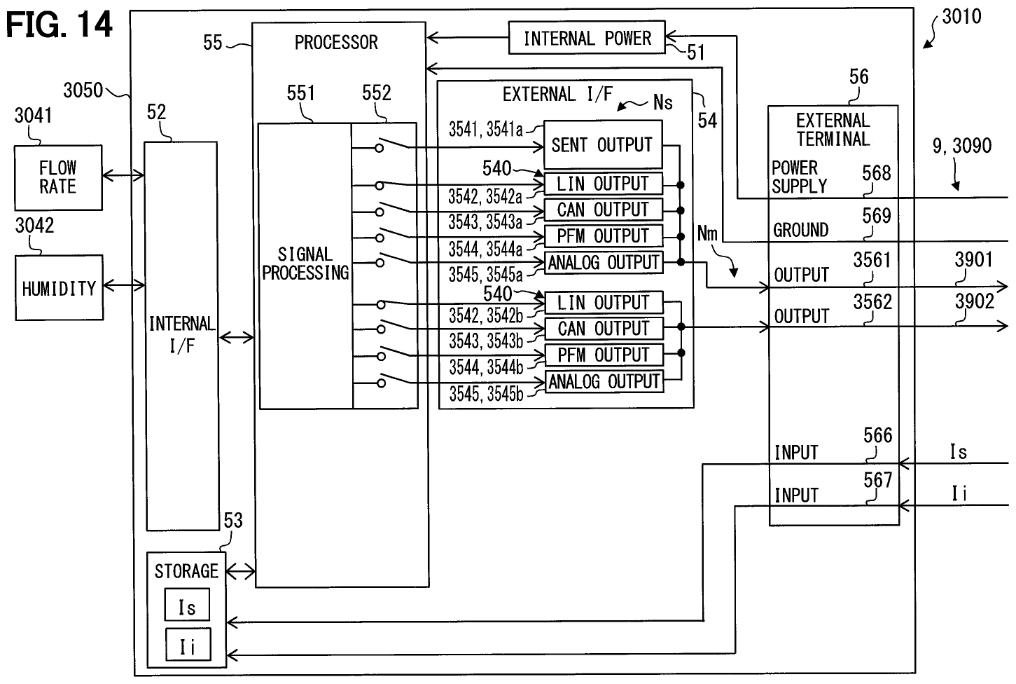

As shown in FIG. 12, the second sensor elements 3042 are disposed so as to protrude to an outside of a housing 20 inside am intake pipe 3, thereby being exposed to an intake passage 3a. The second sensor element 3042 of the resistive type or the like detects a humidity, which is a proportion of water vapor in an intake air flowing through the intake passage 3a, as a “physical quantity”. Therefore, the second sensor element 3042 generates and outputs a detection signal representing the detected humidity as needed. At that time, the humidity detection signal output from the second sensor element 3042 may be either an analog signal or a digital signal that can be processed by an internal interface 52. For that reason, a storage unit 53 of FIGS. 13 and 14 also stores correlation calibration information Ii for calibrating a correlation between the detection value of the humidity by the second sensor element 3042 and the detection signal for a long period of time.

In a conversion circuit 3050 of the physical quantity detection device 3010, a first output unit 3541 among the five output units 3541, 3542, 3543, 3544, and 3545 individually conforming to the communication method of the set number Ns is provided with a single output stage 3541a in the first output unit 3541. An output stage 3541a of the first output unit 3541 is configured to be capable of generating an output signal conforming to a corresponding communication method based on detection signals of the two sensor elements 3041 and 3042 and outputting the output signal to the external terminal unit 56.

In this example, in the first output unit 3541, the output signal from the single output stage 3541a is generated in accordance with the SENT communication method shown in FIG. 2 so that the detection value of the flow rate is represented in a data field Fd and the detection value of the humidity is represented in a status field Fs. As described above, the number of output signals that can be generated by the first output unit 3541 based on the detection signals of the sensor elements 3041 and 3042 is one smaller than the number of the sensor elements 3041 and 3042.

On the other hand, as shown in FIGS. 13 and 14, the second to fifth output units 3542, 3543, 3544, and 3545 other than the first output unit are each provided with two output stages. Each of the output stages of the second to fifth output units 3542, 3543, 3544, and 3545 is configured to be capable of generating an output signal conforming to a corresponding communication method based on the detection signals of the sensor elements 3041 and 3042 and outputting the output signal to the external terminal unit 56.

In this example, in the second output unit 3542, an output signal from the one output stage 3542a shown in FIGS. 13 and 14 is generated so that the detection value of the flow rate is represented by the data field Fd by following the LIN communication method shown in FIG. 3. In the second output unit 3542, an output signal from another output stage 3542b is generated in accordance with the LIN communication method shown in FIG. 3 so that the detection value of the humidity is represented by the data field Fd.

In the third output unit 3543, an output signal from one output stage 3543a shown in FIGS. 13 and 14 is generated so that the detection value of the flow rate is represented by the data field Fd by following the single-line CAN communication method shown in FIG. 4. In the third output unit 3543, an output signal from another output stage 3543b is generated so that the detection value of the humidity is represented by the data field Fd by following the single-line CAN communication method shown in FIG. 4.

In the fourth output unit 3544, an output signal from one output stage 3544a is generated in accordance with the PFM communication method shown in FIG. 5 so that the detection value of the flow rate is represented by a length of a pulse period Tp. In the fourth output unit 3544, an output signal from another output stage 3544b is generated in accordance with the PFM communication method shown in FIG. 5 so that the detection value of the humidity is represented by the length of the pulse period Tp.

In the fifth output unit 3545, an output signal from one output stage 3545a shown in FIGS. 13 and 14 is generated in accordance with the analog voltage communication method shown in FIG. 6 so that the detection value of the flow rate is represented by a magnitude of a voltage Vp. In the fifth output unit 3545, an output signal from another output stage 3545b is generated in accordance with the analog voltage communication method shown in FIG. 6 so that the detection value of the humidity is represented by the magnitude of the voltage Vp.

In FIGS. 13 and 14, the output stages of the output units 3542, 3543, 3544, and 3545 are illustrated separately from each other for easy understanding of the description. Actually, however, such a separate configuration may be adopted, or a configuration in which output stages are grouped for each of the output units 3542, 3543, 3544, and 3545 may be adopted. Therefore, regardless of the configuration, the second to fifth output units 3542, 3543, 3544, and 3545 of the third embodiment can be considered to be configured by using two sets of output stages as one unit.

As described above, the number of output signals that can be generated based on the detection signals of the sensor elements 3041 and 3042 is two for each of the second to fifth output units 3542, 3543, 3544, and 3545. On the other hand, the number of output signals in the first output unit 3541 is one as described above. As described above, in the third embodiment, the maximum number of signals Nm that becomes the maximum value of the number of the output signals that can be generated for each of the output units 3541, 3542, 3543, 3544, and 3545 of the set number Ns is defined as two that is the same as the number of the sensor elements 3041 and 3042.

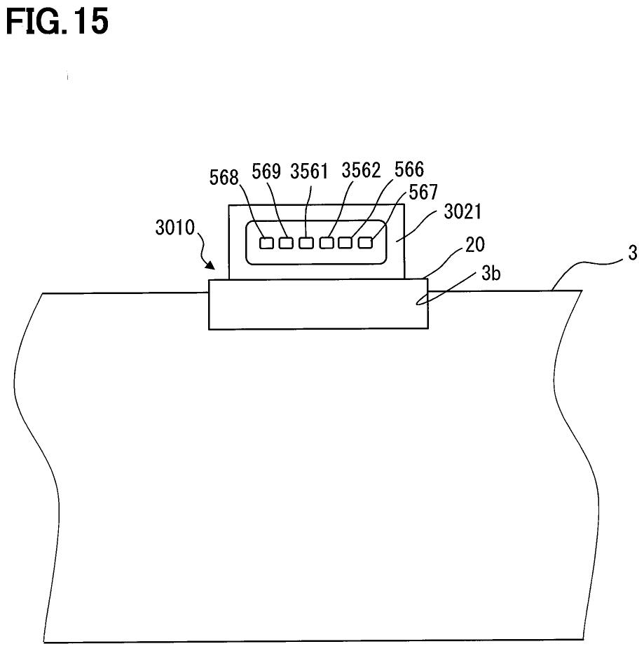

The conversion circuit 3050 of the physical quantity detection device 3010 further includes multiple output terminals 3561 and 3562. The output terminals 3561 and 3562 are made of a conductive hard metal like the other output terminals 566, 567, 568, and 569, and are all included in the connector 3021 as shown in FIG. 15. In this example, also in the fifth embodiment, the connector 3021 is formed in a shape common to the communication methods of the set number Ns, so that the connector 3021 can be mechanically connected to the wire harness 3090 of FIGS. 13 and 14 regardless of the actual communication method applied to the vehicle.

The output stages 3541a, 3542a, 3543a, 3544a, and 3545a of the output units 3541, 3542, 3543, 3544, and 3545 are electrically connected to the common first output terminal 3561, so that the generated output signal can be output to the terminal 3561. On the other hand, the output stages 3542b, 3543b, 3544b, and 3545b of the output units 3542, 3543, 3544, and 3545 other than the first output units 3542, 3543, 3544, and 3545 are electrically connected to the common second output terminal 3562, so that the generated output signal can be output to the terminal 3562.

As described above, the number of the output terminals 3561 and 3562 configured to be capable of outputting the output signal from at least one of the output units 3541, 3542, 3543, 3544, and 3545 is set to two corresponding to the maximum number of signals Nm. In addition, the first output unit 3541 conforming to the SENT communication method is configured to be capable of outputting the single output signal generated less than the maximum number of signals Nm to the first output terminal 3561 serving as one of the output terminals based on the detection signals of the sensor elements 3041 and 3042. Therefore, in the third embodiment, the SENT communication method to which the first output unit 3541 conforms corresponds to a “single signal method”.

However, in a product state in which the actual output unit 540 (the first output unit 3541 in the example of FIG. 13 or the second output unit 3542 in the example of FIG. 14) is selected among the output units 3541, 3542, 3543, 3544, and 3545, an output signal is output only from the unit 540. The respective output terminals 3561 and 3562 are electrically connected to the signal lines 3901 and 3902 included in the wire harness 3090 that connects to the engine ECU 8 as the in-vehicle network 9, individually. Therefore, an output signal output from the actual output unit 540 to only the first output terminal 3561 (an example in FIG. 13) is input to the engine ECU 8 through the signal line 3901. On the other hand, output signals output from the actual output unit 540 to the output terminals 3561 and 3562 (an example in FIG. 14) are input to the engines ECU 8 through the signal lines 3901 and 3902, respectively.

According to the conversion circuit 3050 of the third embodiment described above, the multiple output terminals 3561 and 3562 are provided so that an output signal can be output from at least one of the output units 3541, 3542, 3543, 3544, and 3545 of the set number Ns. In this example, the number of output terminals 3561 and 3562 coincides with the maximum number of signals Nm of output signals that can be generated based on the detection signals of the sensor elements 3041 and 3042 for each of the output units 3541, 3542, 3543, 3544 and 3545. Therefore, the output signal having the maximum number of signals Nm or less generated by the actual output unit 540 conforming to the communication method applied to the vehicle can be output to any of the output terminals 3561 and 3562 having the same number as the number Nm. According to the above configuration, a circuit configuration including the same number of output terminals 3561 and 3562 as the maximum number of signals Nm can be configured by a common production process, thereby being capable of contributing to achievement of high productivity.

Furthermore, in the third embodiment, the SENT communication to which the first output unit 3541 conforms is applied as the “single signal method” included in the communication method of the setting number Ns. As a result, in the first output unit 3541, the single output signal generated to be smaller than the maximum number of signals Nm based on the detection signal of each of the sensor elements 3041 and 3042 is output to one of the multiple output terminals 3561 and 3562. Therefore, the vehicle to which the SENT communication is applied can contribute to the wire saving of the wire harnesses 3090 and improve the communication accuracy.

Further, according to the third embodiment, the connector 21 including all of the output terminals 3561 and 3562 provided in the same number as the maximum number of signals Nm is formed in a shape common to the communication methods of the set number Ns. According to the above configuration, not only the circuit configuration including the same number of output terminals 3561 and 3562 as the maximum number of signals Nm, but also the connector 21 for protecting the output terminals 3561 and 3562 by inclusion can be configured by a common production process to enhance productivity.

### Fourth Embodiment

A fourth embodiment is a modification of the third embodiment.

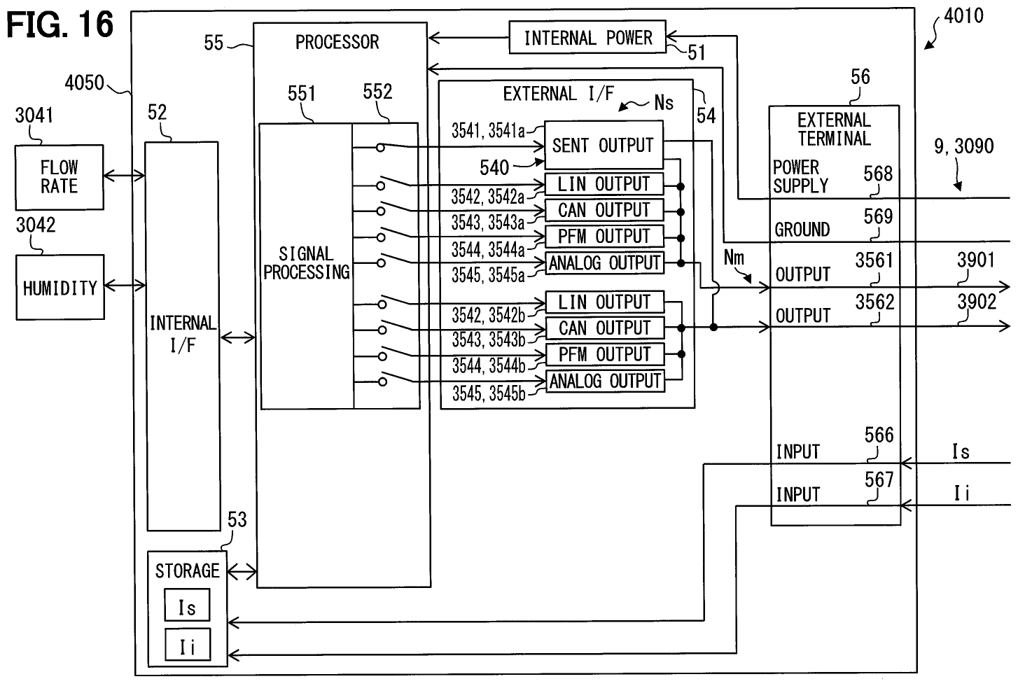

As shown in FIG. 16, in a conversion circuit 4050 of a physical quantity detection device 4010 according to the fourth embodiment, a first output unit 3541 conforming to a SENT communication as a “single signal method” is electrically connected not only to a first output terminal 3561 but also to a second output terminal 3562. As a result, the first output unit 3541 is configured to be able to output a single output signal generated less than the maximum number of signals Nm to each of the different output terminals 3561 and 3562 based on the detection signal of each of sensor elements 3041 and 3042.

In the first output unit 3541 according to the fourth embodiment described above, the single output signal generated less than the maximum number of signals Nm based on the detection signals of the sensor elements 3041 and 3042 is output to each of the different output terminals 3561 and 3562. According to the above configuration, the output signals that are the same for different output terminals 3561 and 3562 are redundantly conveyed from the output terminals 3561 and 3562 by the signal lines 3901 and 3902 of the wire harness 3090. Therefore, even if an abnormality such as a disconnection occurs in one of the signal lines 3901 and 3902, the signal lines 3901 and 3902 can be mutually checked. This makes it possible to contribute to an improve in the reliability of communication while increasing the productivity by making the production process of the circuit configuration common.

### Fifth Embodiment

A fifth embodiment is a modification of the third embodiment.

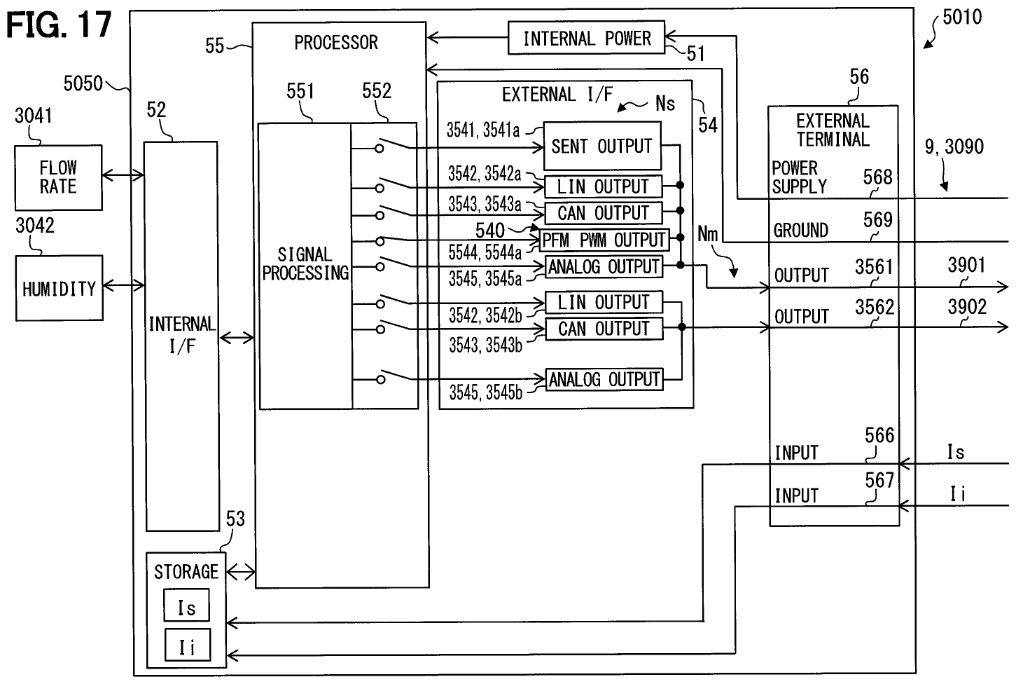

As shown in FIG. 17, in a conversion circuit 5050 of a physical quantity detection device 5010 according to the fifth embodiment, a fourth output unit 5544 is provided with a single output stage 5544a. The output stage 5544a of the fourth output unit 5544 is configured to be capable of generating an output signal conforming to a corresponding communication method based on detection signals of two sensor elements 3041 and 3042 and outputting the output signal to an external terminal unit 56.

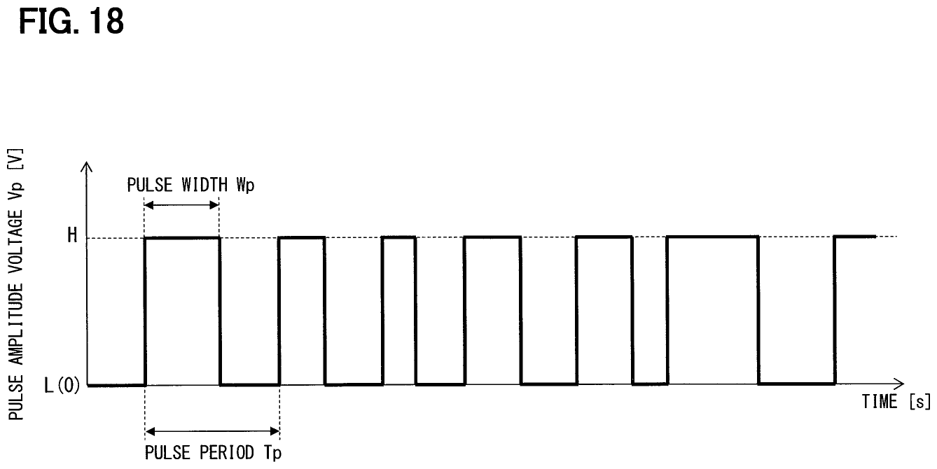

In this example, in the fourth output unit 5544, the output signal from the single output stage 5544a follows a combined communication method of a pulse-frequency modulation (PFM) and a pulse-width modulation (PWM: Pulse Width Modulation) shown in FIG. 18. As a result, the output signal from the output stage 5544a in the fourth output unit 5544 is generated such that the detection value of a flow rate is represented by a length of a pulse period Tp and the detection value of the humidity is represented by a magnitude of the duty ratio Wp/Tp based on a pulse width Wp, at a constant level of a pulse amplitude voltage Vp. As described above, the number of output signals that can be generated in the fourth output unit 5544 based on the detection signals of the sensor elements 3041 and 3042 is one smaller than the number of the sensor elements 3041 and 3042. Therefore, based on the above fact, also in the fifth embodiment of FIG. 17, the maximum number of signals Nm that becomes the maximum value of the number of the output signals that can be generated for each of the output units 3541, 3542, 3543, 5544, and 3545 of the set number Ns is defined as two that is the same number of the sensor elements 3041 and 3042.

The output stage 5544a of the fourth output unit 5544 can output an output signal to a first output terminal 3561 which is electrically connected in common with the output stages 3541a, 3542a, 3543a, and 3545a of the other units 3541, 3542, 3543, and 3545. In response to the above, the output stages 3542b, 3543b, and 3545b of the output units 3542, 3543, and 3545 other than the first and fourth output units can output a raw output signal to the second output terminal 3562 which is electrically connected in common.

As described above, the number of the output terminals 3561 and 3562 of the fifth embodiment configured to be capable of outputting an output signal from at least one of the output units 3541, 3542, 3543, 5544, and 3545 is also set to two that coincide with the maximum number of signals Nm. The fourth output unit 5544 conforming to the combined communication method of PFM and PWM is configured to be capable of outputting a single output signal generated less than the maximum number of signals Nm based on the detection signals of the sensor elements 3041 and 3042 to the first output terminal 3561 serving as one of the output terminals. FIG. 17 shows an example in which the fourth output unit 5544 is selected as the actual output unit 540. Therefore, in the fifth embodiment, the SENT communication method to which the first output unit 3541 conforms and the combined communication method to which the fourth output unit 5544 conforms correspond to a “single signal method”.

According to the conversion circuit 5050 of the fifth embodiment described above, the multiple output terminals 3561 and 3562 are provided so as to be able to output an output signal from at least one of the output units 3541, 3542, 3543, 5544, and 3545 having the set number Ns. In this example, the number of output terminals 3561 and 3562 coincides with the maximum number of signals Nm of output signals that can be generated based on the detection signals of the sensor elements 3041 and 3042 for each of the output units 3541, 3542, 3543, 5544 and 3545. Therefore, according to the same principle as that of the third embodiment, a circuit configuration including the output terminals 3561 and 3562 having the same number as the maximum number of signals Nm can be configured in a common production process, thereby being capable of contributing to the achievement of high productivity.

Furthermore, in the fifth embodiment, the SENT communication with which the first output unit 3541 is compliant and the combined communication method of PFM and PWM with which the fourth output unit 5544 is compliant are applied as the “single signal method” included in the communication method of the set number Ns. As a result, in the output units 3541 and 5544, a single output signal generated to be smaller than the maximum number of signals Nm based on the detection signal of each of the sensor elements 3041 and 3042 is output to one of the multiple output terminals 3561 and 3562. Therefore, the vehicle to which the SENT communication or the combined communication method of PFM and PWM is applied can contribute to the wire saving of the wire harnesses 3090.

### Sixth Embodiment

A sixth embodiment is a modification of the third embodiment.

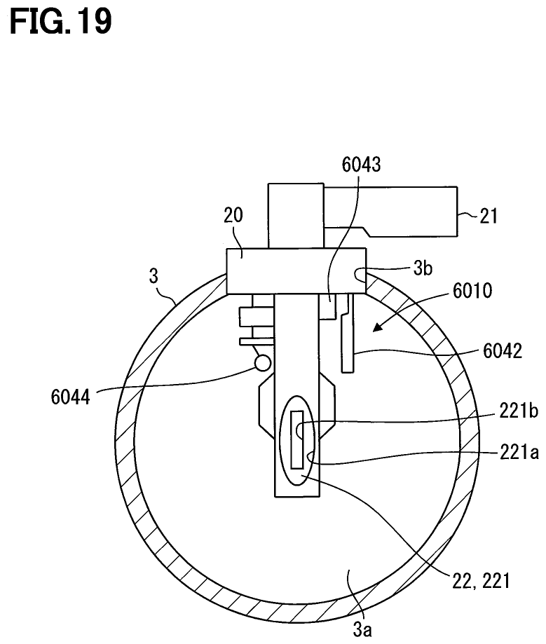

As shown in FIGS. 19 to 21, a physical quantity detection device 6010 according to the sixth embodiment includes multiple sensor elements 6041, 6042, 6043, and 6044 configured to detect different “physical quantities”. Specifically, in addition to the first sensor element 6041 having substantially the same configuration as that of the sensor element 41 of the first embodiment and the second sensor element 6042 having substantially the same configuration as that of the sensor element 3042 of the third embodiment, another third sensor element 6043 and another fourth sensor element 6044 are provided.

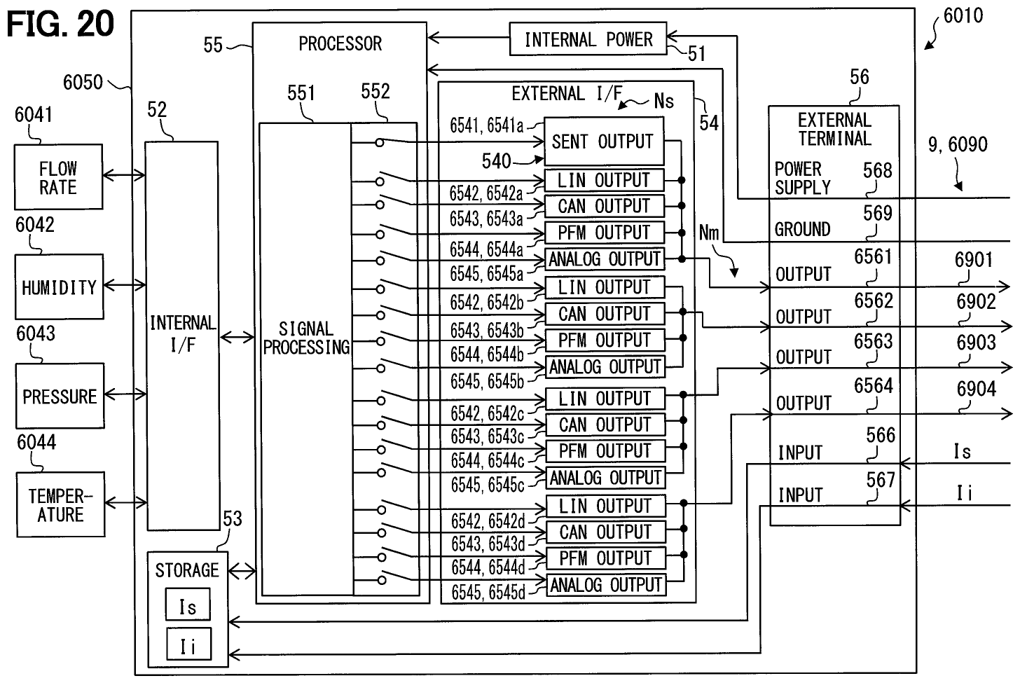

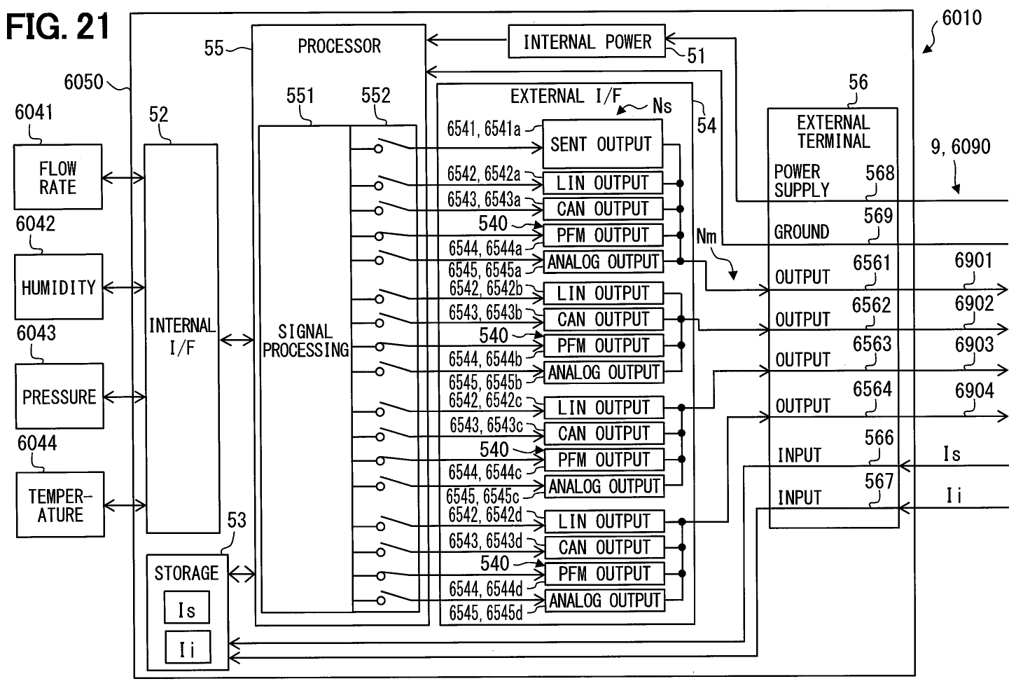

As shown in FIG. 19, the third sensor element 6043 is placed so as to protrude to the outside of a housing 20 inside am intake pipe 3, thereby being exposed to the intake passage 3a. The third sensor element 6043 of the pressure-sensitive type or the like detects a pressure of an intake air flowing through the intake passage 3a as a “physical quantity”. Therefore, the third sensor element 6043 generates and outputs a detection signal representing the detected pressure at any time. At that time, the pressure detection signal output from the third sensor element 6043 may be either an analog signal or a digital signal that can be processed by an internal interface 52. For that reason, correlation calibration information Ii for calibrating a correlation between a detection value of the pressure by the third sensor element 6043 and a detection signal is also stored in a storage unit 53 of FIGS. 20 and 21 for a long period of time.

As shown in FIG. 19, the fourth sensor element 6044 is placed so as to protrude to the outside of the housing 20 inside the intake pipe 3, thereby being exposed to an intake passage 3a. The fourth sensor element 6044, such as a thermistor-type sensor element, detects a temperature of the intake air flowing through the intake passage 3a as a “physical quantity”. Therefore, the fourth sensor element 6044 generates and outputs a detection signal representing the detected temperature as needed. At that time, the detection signal of the temperature output from the fourth sensor element 6044 may be either an analog signal or a digital signal that can be processed by the internal interface 52. For that reason, the correlation calibration information Ii for calibrating the correlation between the detection value of the temperature by the fourth sensor element 6044 and the detection signal is also stored in the storage unit 53 of FIGS. 20 and 21 for a long period of time.

In the conversion circuit 6050 of the physical quantity detection device 6010, the first output unit 6541 among the five output units 6541, 6542, 6543, 6544, and 6545 individually conforming to the communication methods of the set number Ns has substantially the same configuration as that the first output unit 3541 of the third embodiment. On the other hand, four output stages are provided in each of the second to fifth output units 6542, 6543, 6544, and 6545 other than the first output units. Each of the output stages of the second to fifth output units 6542, 6543, 6544, and 6545 is configured to be capable of generating an output signal conforming to a corresponding communication method based on the detection signals of the sensor elements 6041, 6042, 6043, and 6044 and outputting the output signal to the external terminal unit 56.

In this example, the output stages 6542a and 6542b shown in FIGS. 20 and 21 in the second output unit 6542 have substantially the same configuration as that of the output stages 3542a and 3542b in the second output unit 3542 of the third embodiment. In the second output unit 6542, the output signal from another output stage 6542c is generated in accordance with the LIN communication method shown in FIG. 3 so that the detection value of the pressure is represented by a data field Fd. In the second output unit 6542, the output signal from another output stage 6542d is generated according to the LIN communication method shown in FIG. 3 so that the detection value of the temperature is represented by the data field Fd.

The output stages 6543a and 6543b shown in FIGS. 20 and 21 in the third output unit 6543 have substantially the same configuration as that of the output stages 3543a and 3543b in the third output unit 3543 of the third embodiment. In the third output unit 6543, the output signal from another output stage 6543c is generated in accordance with the single-line CAN communication method shown in FIG. 4 so that the detection value of the pressure is represented by the data field Fd. In the third output unit 6543, the output signal from yet another output stage 6543d is generated so as to represent the detection value of the temperature in the data field Fd by following the single-line CAN communication method shown in FIG. 4.

The output stages 6544a and 6544b shown in FIGS. 20 and 21 in the fourth output unit 6544 have substantially the same configuration as that of the output stages 3544a and 3544b in the fourth output unit 3544 of the third embodiment. In the fourth output unit 6544, the output signal from another output stage 6544c is generated in accordance with the PFM communication method shown in FIG. 5 so that the detection value of the pressure is represented by the length of the pulse period Tp. In the fourth output unit 6544, the output signal from yet another output stage 6544d is generated so that the detection value of the temperature is represented by the length of the pulse period Tp by following the PFM communication method shown in FIG. 5.

The output stages 6545a and 6545b shown in FIGS. 20 and 21 in the fifth output unit 6545 have substantially the same configuration as that of the output stages 3545a and 3545b in the fifth output unit 3545 of the third embodiment. In the fifth output unit 6545, the output signal from another output stage 6545c is generated in accordance with the analog voltage communication method shown in FIG. 6 so that the detection value of the pressure is represented by the magnitude of the voltage Vp. In the fifth output unit 6545, the output signal from another output stage 6545d is generated in accordance with the analog voltage communication method shown in FIG. 6 so that the detection value of the temperature is represented by the magnitude of the voltage Vp.

In FIGS. 20 and 21, the output stages of the output units 6542, 6543, 6544, and 6545 are separated from each other to facilitate understanding of the description. Actually, however, such a separate configuration may be adopted, or a configuration in which output stages are grouped for each of the output units 6542, 6543, 6544, and 6545 may be adopted. Therefore, regardless of the configuration, the second to fifth output units 6542, 6543, 6544, and 6545 of the sixth embodiment can be considered to be configured with four sets of output stages as one unit.

As described above, the number of output signals that can be generated based on the detection signals of the sensor elements 6041, 6042, 6043, and 6044 is four for each of the second to fifth output units 6542, 6543, 6544, and 6545. On the other hand, the number of output signals in the first output unit 6541 is one as in the first output unit 3541 of the third embodiment. As described above, in the sixth embodiment, the maximum number of signals Nm that becomes the maximum value of the number of the output signals that can be generated for each of the output units 6541, 6542, 6543, 6544, and 6545 of the set number Ns is defined as four that is the same as the number of the sensor elements 6041, 6042, 6043, and 6044.

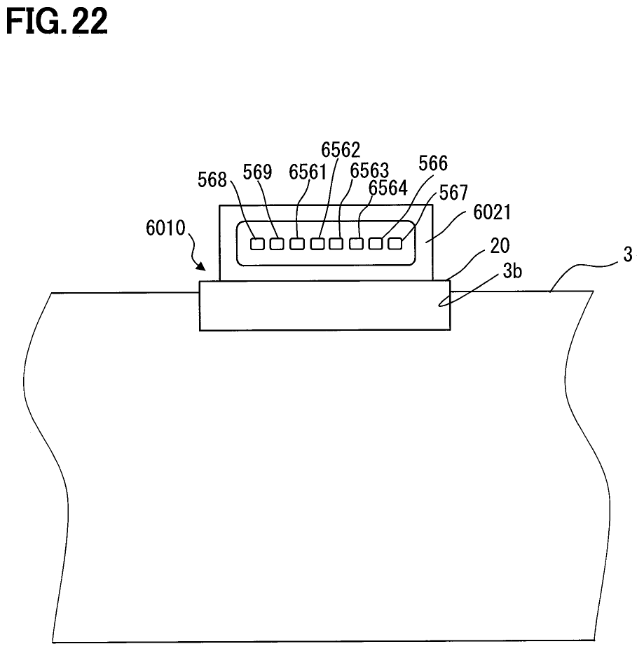

The conversion circuit 6050 of the physical quantity detection device 6010 further includes multiple output terminals 6561, 6562, 6563, and 6564. The output terminals 6561, 6562, 6563, 6563 are made of a conductive hard metal like the other terminals 566, 567, 568, 569, and are all included in the connector 6021 as shown in FIG. 22. In this example, also in the sixth embodiment, the connector 6021 is formed in a shape common to the communication methods of the set number Ns, so that the connector 6021 can be mechanically connected to a wire harness 6090 of FIGS. 20 and 21 regardless of the actual communication method applied to the vehicle.

Output stages 6541a, 6542a, 6543a, 6544a, and 6545a of the output units 6541, 6542, 6543, 6544, and 6545 are electrically connected to a common first output terminal 6561, so that the generated output signal can be output to the terminal 6561. On the other hand, output stages 6542b, 6543b, 6544b, and 6545b of the output units 6542, 6543, 6544, and 6545 other than the first output unit are electrically connected to a common second output terminal 6562, so that the generated output signal can be output to the terminal 6562. At the same time, output stages 6542c, 6543c, 6544c, and 6545c of the output units 6542, 6543, 6544, and 6545 other than the first output unit are electrically connected to a common third output terminal 6563, so that the generated output signal can be output to the terminal 6563. Further, output stages 6542d, 6543d, 6544d, 6545d of the output units 6542, 6543, 6544, and 6545 other than the first output unit are electrically connected to a common fourth output terminal 6564, so that the generated output signal can be output to the terminal 6564.

As described above, the number of output terminals 6561, 6562, 6563, and 6564 configured to be capable of outputting an output signal from at least one of the output units 6541, 6542, 6543, 6544, and 6545 is set to four corresponding to the maximum number of signals Nm. The first output unit 6541 conforming to the SENT communication method is configured to be capable of outputting a single output signal generated less than the maximum number of signals Nm to the first output terminal 6561 serving as any one of the output terminals based on the detection signals of the sensor elements 6041, 6042, 6043, and 6044. Therefore, the SENT communication method to which the first output unit 6541 conforms corresponds to a “single signal method” in the sixth embodiment.

However, in a product state in which the actual output unit 540 (the first output unit 6541 in an example of FIG. 20 or the fourth output unit 6544 in an example of FIG. 21) is selected among the output units 6541, 6542, 6543, 6544, and 6545, an output signal is output only from the unit 540. In this example, the signal lines 6901, 6902, 6903, and 6904 included in the wire harnesses 6090 connected to the engine ECU 8 as the in-vehicle network 9 are electrically connected to the output terminals 6561, 6562, 6563, and 6564, respectively. Therefore, an output signal output from the actual output unit 540 to only the first output terminal 6561 (an example in FIG. 20) is input to the engine ECU 8 through the signal line 6901. On the other hand, the output signals output from the actual output unit 540 to the output terminals 6561, 6562, 6563, and 6564 (an example in FIG. 21) is input to the engine ECU 8 through the signal lines 6901, 6902, 6903, and 6904, respectively.

According to the conversion circuit 6050 of the sixth embodiment described above, multiple output terminals 6561, 6562, 6563, and 6564 are provided so as to be able to output an output signal 45 from at least one of the output units 6541, 6542, 6543, 6544, and 6545 of the set number Ns. In this example, the number of output terminals 6561, 6562, 6563, and 6564 matches the maximum number of signals Nm of output signals that can be generated based on the detection signals of the sensor elements 6041, 6042, 6043, and 6044 for each of the output units 6541, 6542, 6543, 6544, and 6545. Therefore, according to the same principle as in the third embodiment, a circuit configuration including the same number of output terminals 6561, 6562, 6563, and 6564 as the maximum number of signals Nm can be configured in a common production process, thereby being capable of contributing to the achievement of high productivity.

Furthermore, in the sixth embodiment, the SENT communication to which the first output unit 6541 conforms is applied as a “single signal method” included in the communication methods of the set number Ns. Therefore, according to the same principle as that of the third embodiment, the vehicle to which the SENT communication is applied can contribute to the wire saving of the wire harnesses 6090 and improve the communication accuracy.

Further, according to the sixth embodiment, the connector 21 including all of the output terminals 6561, 6562, 6563, and 6564 provided in the same number as the maximum number of signals Nm is formed in a shape common to the communication methods of the set number Ns. Therefore, according to the same principle as that of the third embodiment, not only the circuit configuration but also the connector 21 can be configured in a common production process to enhance productivity.

### Seventh Embodiment

A seventh embodiment is a modification of the sixth embodiment.

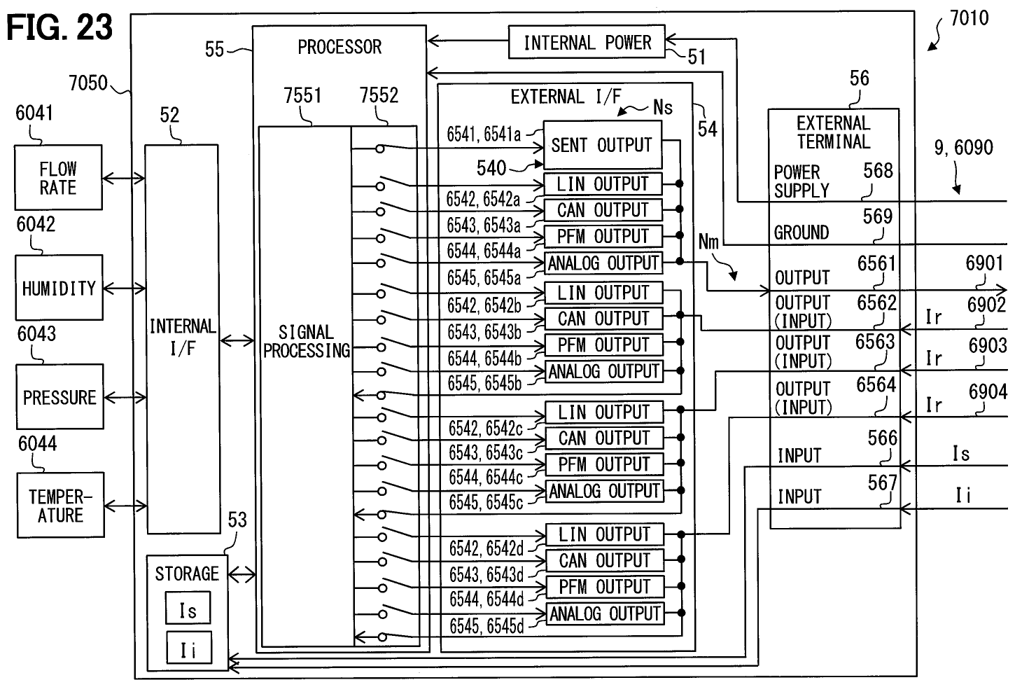

As shown in FIG. 23, in a conversion circuit 7050 of a physical quantity detection device 7010 according to the seventh embodiment, second to fourth output terminals 6562, 6563, and 6564, which are not connected to a first output unit 6541, are also electrically connected to a processor unit 55 through an interface (not shown) configured in accordance with an internal interface 52. Therefore, when the actual applied communication method to the vehicle is the SENT communication, a signal representing correction information Ir is individually and reversely input from the engine ECU 8 to the second to fourth output terminals 6562, 6563, and 6564 through signal lines 6902, 6903, and 6904 of the wire harness 6090. At that time, an output signal of the first output unit 6541 is input from the first output terminal 6561 to the engine ECU 8 through the signal line 6901 of the wire harness 6090. As described above, the output terminals 6562, 6563, and 6564 that receive the signals representing the correction information Ir are different from the first output terminal 6561 that outputs the output signal is output from the first output unit 6541 conforming to the SENT communication method as the “single signal method”.

In the seventh embodiment, the correction information Ir is information required to correct the respective detection values by the sensor elements 6041, 6042, 6043, and 6044 for the pulsation of the intake air in accordance with the operation of the internal combustion engine 2 in which the intake air flows through the intake passage 3a. In this example, the correction information Ir represented by the input signal to the second output terminal 6562 is set to, for example, the engine speed (rotation speed) as the operation information of the internal combustion engine 2. The correction information Ir represented by the input signal to the third output terminal 6563 is set to, for example, the operation information of the throttle device 4. Further, the correction information Ir represented by the input signal to the fourth output terminal 6564 is set to, for example, operation information of at least one of the valve timing adjustment devices 5 and 6.

With the configuration described above, a selection processing block 7552 of the processor unit 55 selects the actual output unit 540 (the first output unit 6541 in an example of FIG. 23) for inputting the detection signal of the sensor element 41 processed by the signal processing block 7551, among the output units 6541, 6542, 6543, 6544, and 6545 of the set number Ns. As a result, when the first output unit 6541 conforming to the SENT communication method is selected as the actual output unit 540, the selection processing block 552 outputs an input signal from the engine ECU 8 to the output terminals 6562, 6563, and 6564 to the signal processing block 7551 of the processor unit 55. In response, the signal processing block 7551 performs necessary signal processing on each detection signal input from the sensor elements 6041, 6042, 6043, and 6044 through the internal interface 52. At that time, in the signal processing of the signal processing block 7551, the correlation calibration information Ii stored in the storage unit 53 is read out, and the detection value represented by the detection signal is calibrated to a value according to the same information Ii. Further, in the signal processing of the signal processing block 7551, the calibrated detection value is corrected as needed based on the correction information Ir represented by the signal input back to each of the output terminals 6562, 6563, and 6564 in accordance with the operation of the internal combustion engine 2.

According to the seventh embodiment described above, the second to fourth output terminals 6562, 6563, and 6564 differ from the first output terminal 6561 for outputting a single output signal from the first output unit 6541 conforming to the SENT communication method as the “single signal method”. Therefore, the second to fourth output terminals 6562, 6563, and 6564 of the vehicle when the SENT communication is applied receive a signal representing the correction information Ir required to correct the detection value of the “physical quantity” in association with the circulation of the intake air in the intake passage 3a. According to the above configuration, in the SENT communication method in which any one of the first output terminals 6561 smaller than the maximum number of signals Nm is used, the remaining second to fourth output terminals 6562, 6563, and 6564 which are not used for outputting the output signal can be effectively used for correcting the detection values of the “physical quantities”. This makes it possible to contribute to achievement of high detection accuracy.

Although multiple embodiments have been described above, the present disclosure is not construed as being limited to these embodiments, and can be applied to various embodiments and combinations within a scope that does not depart from the gist of the present disclosure. Modifications 1 to 18 of the above embodiment will be described. Specifically, in Modification 1 relating to the first to seventh embodiments, at least one of the signal processing blocks 551 and 7551 and the selection processing blocks 552 and 7552 may be configured in hardware by one or multiple ICs different from the processor unit 55.

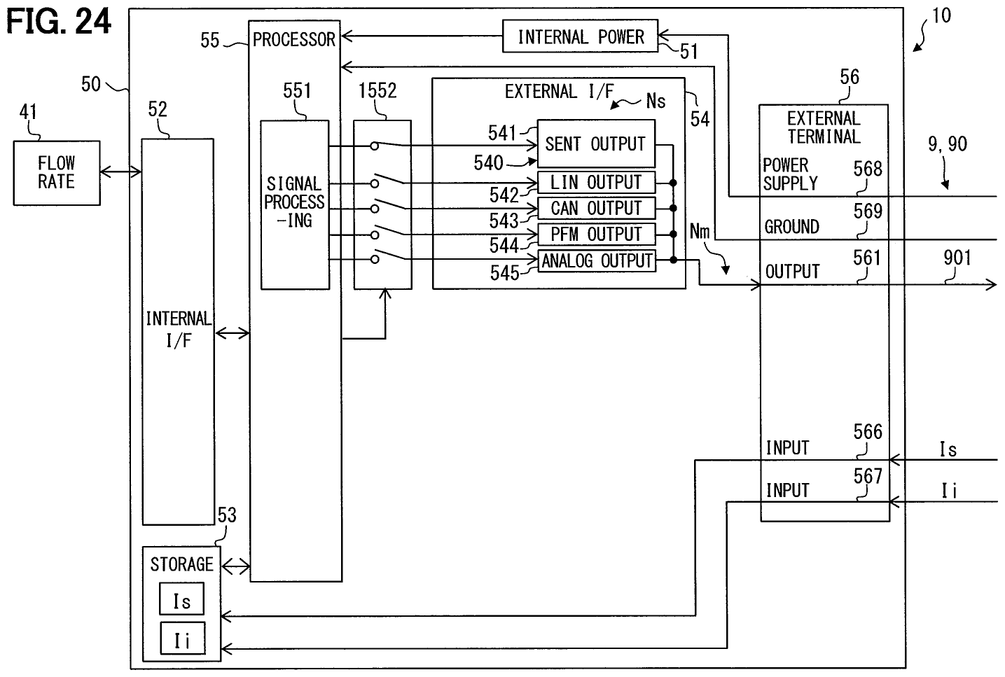

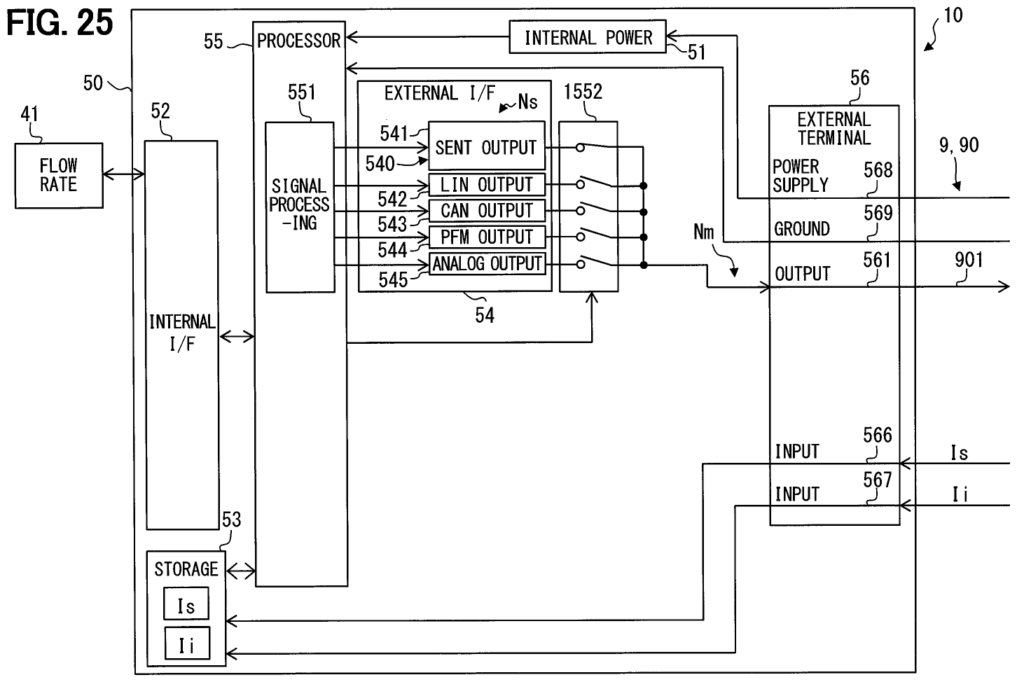

For example, in Modification 1 shown in FIG. 24, a switching circuit unit 1552, which is controlled by the processor unit 55 and performs the function of the selection processing block, is provided between the processor unit 55 and the external interface 54. On the other hand, in Modification 1 shown in FIG. 25, the switching circuit unit 1552, which is controlled by the processor unit 55 and functions as the selection processing block, is provided between the external interface 54 and the external terminal unit 56. However, in Modification 1 shown in FIG. 25, although the detection signal is input from the signal processing block to all the output units, the switching circuit unit 1552 permits the output of the output signal to the output terminal only from the actual output unit 540 among the output units. Therefore, in Modifications 1 of FIGS. 24 and 25, the switching circuit unit 1552 corresponds to a “selection unit”. FIGS. 24 and 25 representatively show Modification 1 relating to the first embodiment.

In Modification 2 related to the first to seventh embodiments, only two to four of the five communication methods described above may be assumed as the methods applied to the vehicle. In Modification 3 of the first to seventh embodiments, a method other than that described instead of or in addition to at least one of the five communication methods described above, a method not described above may be assumed as an application method for the vehicle. In the case of Modifications 2 and 3, the number of output units is determined corresponding to the number of communication methods assumed as the method applied to the vehicle.

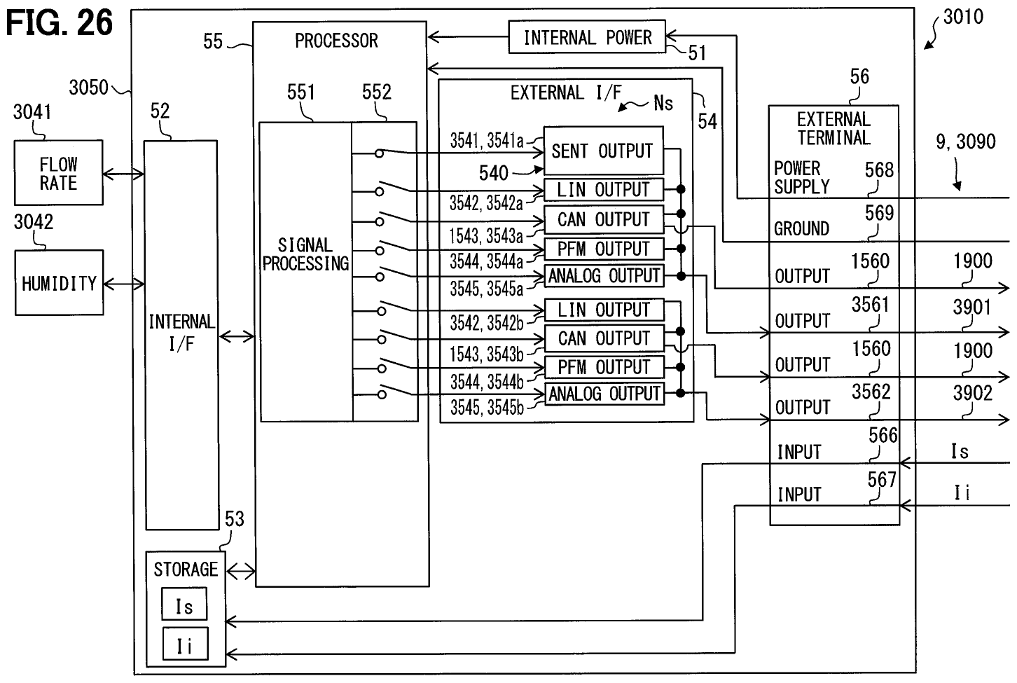

For example, in Modification 3 shown in FIG. 26, a third output unit 1543 may be configured to conform to the two-line differential voltage type high-speed CAN communication method instead of the single-line CAN communication method. In the case of Modification 3, output terminals 1560 electrically connected only to the third output unit 1543 are additionally provided for the number of output signals output from the unit 1543. FIG. 26 representatively shows Modification 3 including a signal line 1900 of the wire harness 3090 electrically connected to the output terminal 1560 in the third embodiment.

In Modification 4 relating to the first to seventh embodiments, the sensor elements 41, 3041, and 6041 may be exposed to the intake passage 3a outside the housing 20. In Modification 5 relating to the third to seventh embodiments, the sensor elements 3042 and 6042 may be exposed to the bypass passage 22 (in particular, the second passage portion 222 according to the sensor element 41 of the first embodiment) inside the housing 20. In Modification 6 related to the sixth and seventh embodiments, at least one of the sensor elements 6043 and 6044 may be exposed to the bypass passage 22 (in particular, the second passage portion 222 according to the sensor element 41 of the first embodiment) inside the housing 20.

In Modification 7 relating to the first and second embodiments, “physical quantities” other than the flow rate, such as those described in the sixth embodiment, for example, may be detected by the sensor element 41. In Modification 8 relating to the third to fifth embodiments, “physical quantities” other than the flow rate and the humidity, such as those described in the sixth embodiment, for example, may be detected by at least one of the sensor elements 3041 and 3042. In Modification 9 relating to the sixth and seventh embodiments, for example, “physical quantities” other than those described in the sixth embodiment may be detected by at least one of the sensor elements 6041, 6042, 6043, and 6044.

In Modification 10 relating to the sixth and seventh embodiments, at least one sensor element for detecting the “physical quantity” different from any of the sensor elements 6041, 6042, 6043, and 6044 may be additionally provided. In other words, in Modification 10, the number of sensor elements may be set to five or more. In the case of Modification 10, the number of output terminals may be set to five or more in accordance with the maximum number of signals Nm corresponding to the number of sensor elements, for example.

In Modification 11 relating to the first to seventh embodiments, the shapes of the connectors 21, 3021, and 6021 may be different depending on the communication method applied to the vehicle. In Modification 12 relating to the first and third to seventh embodiments, at least one of the input terminals 566 and 567 may not be provided. In the case of Modification 12, the storage unit 53 in which at least one of the information Is and Ii corresponding to the input terminal which is not provided is stored in advance may be incorporated in the conversion circuit, or at least one of the information Is and Ii may not be stored in the storage unit 53.

In Modification 13 relating to the third to seventh embodiments, an input terminal 2566 according to the second embodiment may be provided instead of the input terminals 566 and 567. In Modification 14 relating to the fifth to seventh embodiments, the output units 3541, 5544, and 6541 may be electrically connected not only to the output terminals 3561, 6561 but also to at least one of the other output terminals in accordance with the fourth embodiment.

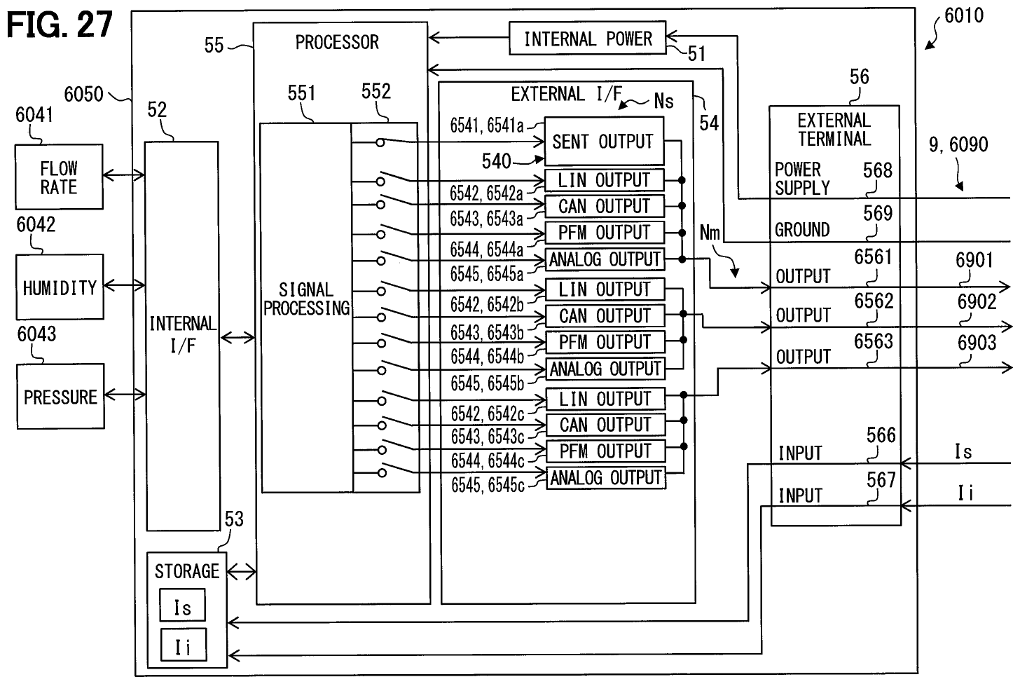

In Modification 15 relating to the sixth and seventh embodiments, instead of the output unit 3544 conforming to the PFM communication method, an output unit 6544 conforming to the combined communication method of PFM and PWM may be provided in accordance with the fifth embodiment. In Modification 16 relating to the sixth and seventh embodiments, as shown in FIG. 27, any one of the sensor elements 6041, 6042, 6043, and 6044 may not be provided. In the case of Modification 16, the output stage and the terminal corresponding to the sensor element (fourth sensor element 6044 in an example of FIG. 27) which is not provided are not provided as one of the output terminals. FIG. 27 representatively shows Modification 16 relating to the sixth embodiment.

In the modification 17 relating to the first to seventh embodiments, the “physical quantity” of the “gas” flowing through a passage other than the intake passage 3a in a vehicle, such as the exhaust passage 7a in FIG. 1, may be detected by the physical quantity detection device. In the modification 18 related to the first to seventh embodiments, for example, the medical intake air amount detection or the like other than the vehicle may be set as the “mounting target” of the physical quantity detection device.

Although the present disclosure has been described in accordance with the examples, it is understood that the present disclosure is not limited to such examples or structures. The present disclosure encompasses various modifications and variations within the scope of equivalents. In addition, various combinations and configurations, as well as other combinations and configurations that include only one element, more, or less, are within the scope and spirit of the present disclosure.

1. A physical quantity detection device for detecting a physical quantity of a gas that flows through a passage in a mounting target, the physical quantity detection device comprising:
a sensor element that generates a detection signal of the physical quantity; and
a conversion circuit that converts the detection signal generated by the sensor element into an output signal, wherein
the conversion circuit includes:
a set number of output units each corresponding to a respective one of a set number of communication methods, each of the output units being capable of generating the output signal conforming to their corresponding communication method, the set number being two or more;
a storage unit that stores method specifying information which specifies a communication method, to be applied to the mounting target, among the set number of communication methods; and
a selection unit that selects an output unit, which outputs the output signal, among the set number of output units according to the method specifying information stored in the storage unit.

2. The physical quantity detection device according to claim 1, wherein the conversion circuit includes an input terminal that receives a signal representing the method specifying information to store the method specifying information in the storage unit.

3. The physical quantity detection device according to claim 2, wherein the input terminal receives a signal representing correlation calibration information to be stored in the storage unit for calibrating a correlation between the detection value of the physical quantity by the sensor element and the detection signal.

4. The physical quantity detection device according to claim 1, further comprising:
a connector formed in a shape common to the set number of communication methods, wherein
the conversion circuit includes a single output terminal configured to output the output signal from each of the set number of output units, the output terminal being housed within the connector.

5. The physical quantity detection device according to claim 1, wherein
the conversion circuit includes a plurality of output terminals configured to output the output signal from at least one of the set number of output units,
a plurality of the sensor elements are provided to detect different physical quantities, and
when a maximum value of the number of the output signals that can be generated based on the detection signal of each of the sensor elements is defined as a maximum number of signals for each set number of output units, the number of the output terminals coincides with the maximum number of signals.

6. The physical quantity detection device according to claim 5, wherein
the set number of communication methods includes a single signal method, and
the output unit among the set number of output units that conforms to the single signal method outputs a single output signal, generated in fewer numbers than the maximum number of signals based on the detection signal of each of the sensor elements, to any one of the output terminals.

7. The physical quantity detection device according to claim 6, wherein a signal representing correction information, used for correcting the detection value of the physical quantity by the sensor element in association with the flow of the gas through the passage, is input to an output terminal different from the output terminal that outputs the output signal from the output unit among the set number of output units that conforms to the single signal method.

8. The physical quantity detection device according to claim 5, wherein
the set number of communication methods include a single signal method, and
the output unit among the set number of output units that conforms to the single signal method outputs a single output signal, generated in fewer numbers than the maximum number of signals based on the detection signal of each of the sensor elements, to each of the different output terminals.

9. The physical quantity detection device according to claim 6, wherein the single signal method is a SENT communication method.

10. The physical quantity detection device according to claim 6, wherein the single signal method is a combined communication method of pulse-frequency modulation and pulse-width modulation which carries the output signal in which the different physical quantities are represented by a pulse frequency and a duty ratio, respectively.

11. The physical quantity detection device according to claim 5, further comprising a connector formed in a shape common to the set number of communication methods, the output terminals being housed within the connector.

12. A physical quantity detection device for detecting a physical quantity of a gas that flows through a passage in a mounting target, the physical quantity detection device comprising:
a flow rate sensor configured to a detection signal of the physical quantity; and
a conversion circuit configured to convert the detection signal generated by the sensor element into an output signal, wherein
the conversion circuit includes:
an interface circuit including a set number of output units each corresponding to a respective one of a set number of communication methods, each of the output units being configured to generate the output signal conforming to their corresponding communication method, the set number being two or more;
a memory that stores method specifying information which specifies a communication method, to be applied to the mounting target, among the set number of communication methods; and
a processing circuit configured to select an output unit among the set number of output units for outputting the output signal according to the method specifying information stored in the storage unit.
